(19) United States
(12) Patent Application Publication
(10) Pub. No.: US 2011/0305355 A1
(43) Pub. Date: Dec. 15, 2011

(54) VIBRATION DIRECTION CONVERTER PART FOR SPEAKER DEVICE AND SPEAKER DEVICE

(75) Inventors: Minoru Horigome, Yamagata (JP); Toshihiro Hikichi, Yamagata (JP); Tempei Katsuta, Yamagata (JP); Kodai Nagasawa, Yamagata (JP); Satoshi Hachiya, Yamagata (JP)

(73) Assignees: TOHOKU PIONEER CORPORATION, Tendo-shi, Yamagata (JP); PIONEER CORPORATION, Kawasaki-shi, Kanagawa (JP)

(21) Appl. No.: 13/203,650

(22) PCT Filed: Feb. 27, 2009
(86) PCT No.: PCT/JP2009/053752

§ 371 Date: Aug. 26, 2011

(51) Int. Cl. H04R 9/00

(52) U.S. Cl. 381/162

(57) ABSTRACT

A vibration direction converter part for speaker device direction converting a vibration of a voice coil supporting part supporting a voice coil, and vibrating a diaphragm in the direction different from the direction of the vibration of the voice coil supporting part, has a rigid link part angle-variably and obliquely disposed between the voice coil supporting part and the diaphragm, and hinge parts formed at both end parts of the link part. The hinge part is formed with a bendable continuous member continuing between both side parts across the hinge part.

### BACKGROUND OF THE INVENTION

1. Field of the Invention

The present invention relates to a vibration direction converter part for speaker device and the speaker device.

2. Related Art

FIG. 1 shows a conventional speaker device. As a general speaker device, a dynamic speaker device as disclosed is known (for example, see patent literature 1). For example, as shown in FIG. 1, the dynamic speaker device described in this publication includes a frame 3J, a cone-shaped diaphragm 21J, an edge 4J which supports the diaphragm 21J to the frame 3J, a voice coil bobbin 610J joined to the inner periphery of the diaphragm 21J, a damper 7J which supports the voice coil bobbin 610J to the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by the Lorentz force developed in the voice coil 611J in the magnetic gap and the diaphragm 21J is driven by the vibration.

[Patent literature 1] Publication of unexamined patent application H8-149596 (FIG. 1)

### SUMMARY

The general dynamic speaker device described above is, for example as shown in FIG. 1, configured such that the voice coil 611J is disposed opposite to the sound emission side of the diaphragm 21J, and the direction of the vibration of the voice coil 611J and the voice coil bobbin 610J is the same as the direction of the vibration of the diaphragm 21J. In such a speaker device, a region for vibration of the diaphragm 10J, a region for vibration of the voice coil bobbin 610J, and a region for arranging the magnetic circuit, etc. are formed along the direction of the vibration (sound emission direction) of the diaphragm 21J. Accordingly, the total height of the speaker device inevitably becomes comparatively large.

Specifically, as shown in FIG. 1, the dimension of the speaker device along the direction of the vibration of the diaphragm 21J is defined by: (a) the height of the cone-shaped diaphragm 21J along the direction of the vibration plus the total height of the edge 4J which supports the diaphragm 21J to the frame 3J, (b) the height of the voice coil bobbin from the junction of the diaphragm 21J and the voice coil bobbin 610J to the upper end of the voice coil 611J, (c) the height of the voice coil, (d) the height mainly of the magnet of the magnetic circuit, and (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to obtain a sufficient driving force. Accordingly, particularly in a speaker device for large volume, the total height of the speaker device inevitably becomes large.

Since the direction of the vibration of the voice coil bobbin 610J is the same direction as the direction of the vibration of the diaphragm 21J in conventional speaker devices as described above, the total height of the speaker devices inevitably becomes large to ensure the vibration stroke of the voice coil bobbin 610J, when seeking a large volume of sound by increasing the amplitude of the diaphragm 21J. Thus, it becomes difficult to make a device thin. In other words, making a device thin and securing a large volume of sound is contradictory.

Nevertheless, in order to efficiently transmit the vibration of the voice coil 611J to the diaphragm 21J, a direct transmission of the vibration from the voice coil 611J to the diaphragm 21J, i.e. the alignment of the direction of the vibration of the voice coil 611J and the direction of the vibration of the diaphragm 21J is preferable. In the case that the direction of the vibration of the voice coil 611J and the direction of the vibration of the diaphragm 21J are different, the vibration of the voice coil 611J may not be securely transmitted to the diaphragm 21J, which may cause deterioration of the reproduction efficiency of the speaker device.

On the other hand, in a conventional dynamic type speaker device, since the voice coil bobbin 610J is joined to an inner periphery part of the diaphragm 21J having cone-shape and a driving force is transmitted from the voice coil bobbin 610J to the inner periphery part of the diaphragm 21J, it is comparatively difficult to drive the whole diaphragm substantially in the same phase. Therefore, a speaker device allowing the whole diaphragm to vibrate substantially in the same phase is desired.

For example, a condenser type speaker device is known as a thin speaker device. The condenser type speaker device has such a configuration that a diaphragm (movable electrode) and a fixed electrode are arranged opposite to each other. In this speaker device, the diaphragm is displaced by application of a DC voltage across the electrodes, and when a signal superimposed with an audio signal is inputted to the electrodes, the diaphragm vibrates in response to the signal. In the above-mentioned condenser type speaker device, however, if the audio signal with comparatively large amplitude of vibration is inputted, a driving force may nonlinearly vary considerably and thereby the quality of reproduced sound may be comparatively deteriorated.

One or more embodiments of the present invention provides a thin speaker device capable of emitting a loud reproduced sound with a comparatively simple configuration, a speaker device with a high reproduction efficiency capable of securely transmitting the vibration of the voice coil to the diaphragm, a thin speaker device capable of emitting a high-quality reproduced sound with a comparatively simple configuration, or a thin speaker device capable of vibrating the diaphragm substantially in the same phase with a comparatively simple configuration.

A thin speaker device which can emit loud reproduced sound with a comparatively simple structure can be obtained by vibrating the diaphragm in the different direction from the direction of the vibration of the voice coil. When the direction of the vibration of the voice coil is urged to convert a different direction by using a mechanical link body, the hinge part of the link body is required to have durability against the high-speed repeated vibration which is required for a speaker device, and is required to have flexibility which prevents occurrence of abnormal noise even in the high-speed repeated vibration.

Further, in order to transmit the vibration of the voice coil to the diaphragm by direction converting the direction of the voice coil, it is required that the vibration of the voice coil is efficiently and accurately reproduced even after the direction converting, as well as it is required that no mechanical distortion occurs in the link body and the link body itself is lightweight. Also, the ease of operation in incorporating the link body into the speaker device and the manufacturability in manufacturing the link body itself are required.

A vibration direction converter part for speaker device direction converting a vibration of a voice coil supporting part supporting a voice coil, and vibrating a diaphragm in the direction different from the direction of the vibration of the voice coil supporting part. The vibration direction converter part includes a rigid link part angle-variably and obliquely disposed between the voice coil supporting part and the diaphragm, and hinge parts formed at both end parts of the link part, wherein the hinge part is formed with a bendable continuous member continuing between both side parts across the hinge part.

A speaker device includes a diaphragm, a frame vibratably supporting the diaphragm in the direction of the vibration and a driving part provided at the frame, applying a vibration to the diaphragm in response to an audio signal. The driving part includes a magnetic circuit forming a magnetic gap in the direction different from the direction of the vibration of the diaphragm, a voice coil supporting part supporting a voice coil to which an audio signal is inputted, being vibratably supported along the magnetic gap a vibration direction converter part direction converting the vibration of the voice coil supporting part and transmitting the vibration to the diaphragm. The vibration direction converter part includes a rigid link part angle-variably and obliquely disposed between the voice coil supporting part and the diaphragm and hinge parts formed at both end parts of the link part. The hinge part is formed with a bendable continuous member continuing between both side parts across the hinge part.

### BRIEF DESCRIPTION OF THE DRAWINGS

FIG. 1 is a view illustrating a prior art;

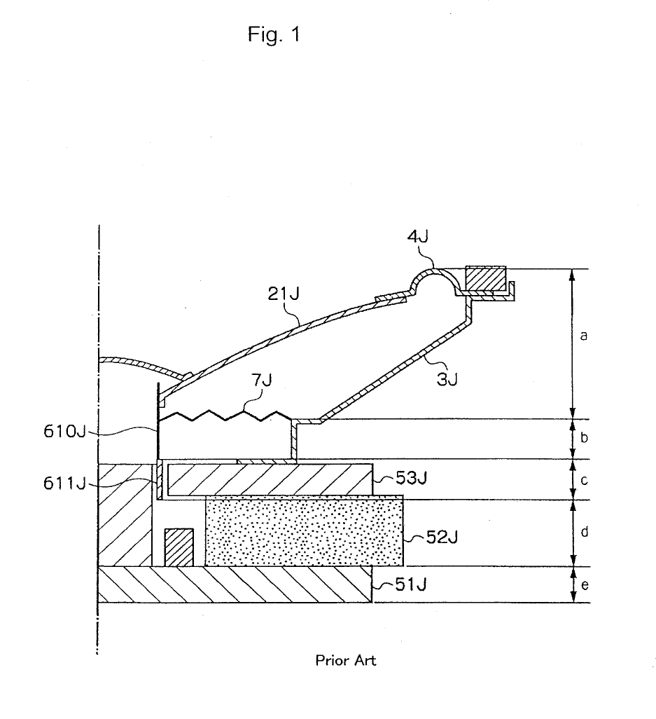

FIGS. 2(a)-2(b) are views illustrating a speaker device provided with a vibration direction converter part for speaker device according to an embodiment of the present invention (FIG. 2(a) is a cross-sectional view taken along the X axial direction, and FIG. 2(b) is a view illustrating the operation of a driving part);

FIGS. 3(a)-3(c) are views illustrating an example of the vibration direction converter part according to an embodiment of the present invention (FIG. 3(a) is a side view, FIG. 3(b) is a perspective view, and FIG. 3 (c) is an enlarged view of the part A in FIG. 3(b));

FIGS. 4(a)-4(c) are views illustrating another example of forming the vibration direction converter part according to an embodiment of the present invention;

FIGS. 5(a)-5(d) are views illustrating a continuous member of the vibration direction converter part according to an embodiment of the present invention;

FIGS. 6(a)-6(b) are views illustrating an example of integrally forming the continuous member and a rigidity member by insert molding;

FIGS. 7(a)-7(d) are views illustrating an example of forming a hinge part;

FIGS. 8(a)-8(b) are views illustrating a speaker device according to another embodiment of the present invention (FIG. 8(a) is a cross-sectional view taken along the X axial direction, and Fig. (b) is a view illustrating the operation of the driving part);

FIGS. 9(a)-9(b) are views illustrating a speaker device according to another embodiment of the present invention (FIG. 8(a) is a cross-sectional view taken along the X axial direction, and FIG. 8(b) is a view illustrating the operation of the driving part);

FIGS. 10(a)-10(b) are views illustrating the vibration direction converter part used in the speaker device according to the embodiment shown in FIG. 9 (FIG. 10(a) is a perspective view and FIG. 10(b) is an enlarged view of the part A in FIG. 10(a));

FIGS. 11(a)-11(b) are views illustrating the vibration direction converter part used in the speaker device according to the embodiment shown in FIG. 9 (FIG. 11(a) is a plan view illustrating the hinge part the overall part of which is extended and flattened, and FIG. 11(b) is a side view illustrating the hinge part the overall part of which is extended and flattened);

FIGS. 12(a)-12(b) are views illustrating another example of the vibration direction converter part according to an embodiment of the present invention (FIG. 12(a) is a side view and FIG. 12(b) is a perspective view);

FIG. 13 is a view illustrating another example of the vibration direction converter part according to an embodiment of the present invention (operational view);

FIGS. 14(a)-14(c) illustrating another example of the vibration direction converter part according to an embodiment of the present invention;

FIGS. 15(a)-15(b) are views illustrating an example of an improvement of the embodiment shown in FIG. 12;

FIGS. 16(a)-16(c) are views illustrating a variation of the vibration direction converter part;

FIG. 17 is a view illustrating a speaker device according to another embodiment of the present invention;

FIG. 18 is a view illustrating a specific example of the holding body in the voice coil supporting part using a holding part;

FIGS. 19(a)-19(b) are views illustrating a voice coil supporting part, a connecting part, a holding part and an attachment unit (FIG. 19(a) is a perspective view which is viewed from the intermediate direction between the X axial direction and the Y axial direction and FIG. 19(b) is a perspective view which is viewed from the direction opposite the direction shown in FIG. 19(a));

FIGS. 20(a)-20(c) are views illustrating a specific example of a magnetic circuit;

FIGS. 21(a)-21(c) are views illustrating the speaker device according to an embodiment of the present invention;

FIGS. 22(a)-22(b) are views illustrating an example of carrying the speaker device according to an embodiment of the present invention; and

FIG. 23 is a view illustrating an example of carrying the speaker device according to an embodiment of the present invention.

### DETAILED DESCRIPTION

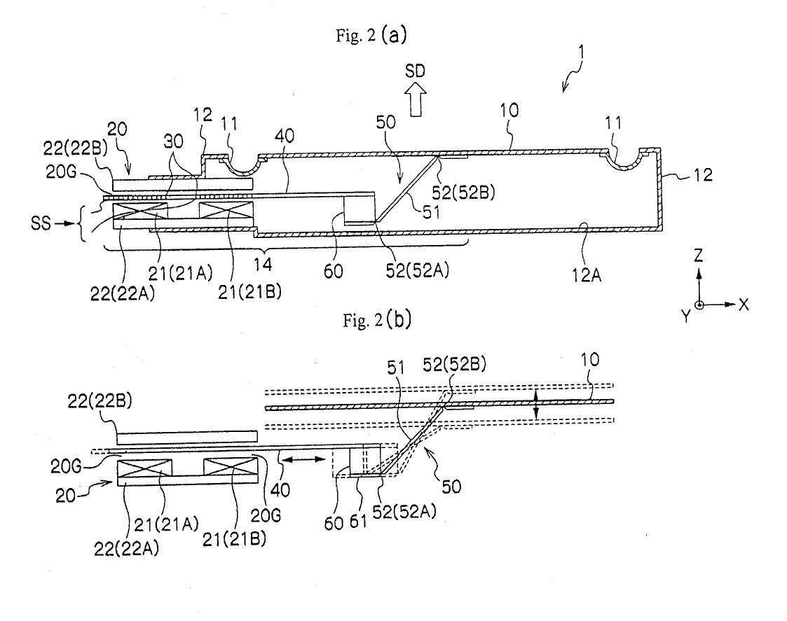

Hereinafter, embodiments of the present invention are described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 2 is a view illustrating a speaker device including a vibration direction converter part for speaker device according to an embodiment of the present invention (FIG. 2(a) is a cross-sectional view taken in the X axial direction, and FIG. 2(b) is a view illustrating the operation of a driving part). A speaker device 1 includes a diaphragm 10, a frame 12 which vibratably supports the diaphragm 10 in the direction of vibration, and a driving part 14 which is provided at a frame 12 and applies vibration to the diaphragm 10 in response to an audio signal, wherein the driving part 14 includes a magnetic circuit 20 which forms a magnetic gap 20G in the different direction from the direction of the vibration of the diaphragm 10, a voice coil supporting part 40 supporting a voice coil 30 to which an audio signal SS is inputted, being vibratably supported along the magnetic gap 20G, and a vibration direction converter part 50 which converts direction of the vibration of the voice coil supporting part 40 and transmits the vibration to the diaphragm 10. In the drawings, the direction of the vibration of the voice coil supporting part 40 is defined as the X axial direction and two directions orthogonal to the X axial direction are defined as the Y axial direction and the Z axial direction.

The vibration direction converter part 50 includes a rigid link part 51 and hinge parts 52 (52A, 52B). The link part 51 is angle-variably and obliquely disposed between the voice coil supporting part 40 and the diaphragm 10. The hinge parts 52 are formed at both ends of the link part 51, and each of the hinge parts 52 is formed with a bendable continuous member which continues between both side parts across the hinge parts 52.

In the speaker device 1 as described above, when an audio signal SS is inputted to the voice coil 30 of the driving part 14, a Lorentz force is generated at the voice coil 30 which is arranged at the magnetic gap 20G in the magnetic circuit 20 and the voice coil supporting part 40 vibrates in the different direction (X axial direction) from the direction of the vibration of the diaphragm 10, which in one or more embodiments of the present invention, is in the direction orthogonal to the direction of the vibration of the diaphragm. In response to the above vibration, the vibration direction converter part 50 operates to direction convert the vibration of the voice coil supporting part 40 and transmit the vibration to the diaphragm 10. The diaphragm 10 vibrates via the vibration direction converter part 50 in the direction of the vibration (for example, in the Z axial direction orthogonal to the vibration of the voice coil supporting part 40) different from the direction of the vibration of the voice coil supporting part 40 in response to the transmitted driving force.

In a general speaker device, for example, a voice coil bobbin is disposed in the rear side of the diaphragm, and the direction of the vibration of the diaphragm and the direction of the vibration of the voice coil bobbin are configured to be aligned in the similar direction, thus the region for the vibration of the diaphragm and the voice coil bobbin is required in the direction of the vibration, thereby comparatively increasing the width (total height) of the speaker device in the sound emission direction.

In contrast, the speaker device 1 according to an embodiment of the present invention is provided with a magnetic circuit 20 having a magnetic gap 20G which is formed in the different direction from the direction of the vibration of the diaphragm 10, which according to one or more embodiments of the present invention, is in the direction orthogonal to the direction of the vibration of the diaphragm 10, the voice coil supporting part 40 which vibrates along the magnetic circuit 20, and a rigid vibration direction converter part 50 which converts the direction of the vibration of the voice coil supporting part 40 and transmits the vibration to the diaphragm 10, and thereby the width of the speaker device 1 is comparatively smaller than the aforementioned general speaker device in the sound emission direction SD. That is, a thin speaker device can be provided. Also, since the vibration stroke of the voice coil supporting part 40 can be set in the direction which has little effect on the total height of the speaker device 1, even when the vibration stroke of the voice coil supporting part 40, that is, the vibration amplitude of the diaphragm 10 is increased, the speaker device 1 can be easily made thin. Thereby, the speaker device 1 can balance being thin with producing loud sound.

The hinge parts 52 of the vibration direction converter part 50 are formed with a bendable continuous member which continues between both side parts across the hinge parts 52. Thus, the hinge parts 52 can be formed only by folding the bendable continuous member, thereby the hinge parts 52 can be easily formed. Also, since the hinge parts 52 have little seam, it is possible to form the hinge parts 52 that can fully withstand the bends repeatedly caused by the vibration of the voice coil supporting part 40 upon sound reproducing by making the continuous member from a durable member. Further, by making the continuous member from a flexible material, abnormal noise can be prevented from occurring upon repeated bends, thereby preferable acoustic quality of the speaker device 1 can be maintained.

Each part of the speaker device 1 is further described in detail. The diaphragm 10 is vibratably supported at the frame 12 in the direction of the vibration (Z axial direction) as shown in the drawing. When the speaker is driven, the diaphragm 10 emits a sound wave in the sound emission direction SD. Further, the diaphragm 10 is supported at the frame 12 via an edge 11, and the movement in the direction other than the direction of the vibration, specifically in the X axial direction or Y axial direction, is regulated by the edge 11. The edge 11 and the diaphragm 10 may be integrally formed.

As the forming materials of the diaphragm 10, for example, resin materials, metal materials, paper materials, fabric materials, ceramic materials, compound materials and so forth may be employed. For example, according to one or more embodiments of the present invention, the diaphragm 10 has rigidity. The diaphragm 10, for example, may be formed in a prescribed shape such as a tabular shape, a dome shape, a cone shape, etc. In the example shown in the drawing, the diaphragm 10 is formed in a tabular shape, and is supported along the tabular bottom face 12A of the frame 12. In one or more embodiments of the present invention, the speaker device is made thin by the diaphragm 10 having a tabular shape. Further, the shape (planar shape) of the diaphragm 10 viewed from the sound emission direction can be formed in a prescribed shape such as a rectangular shape, an elliptical shape, a circular shape, a polygonal shape and so forth.

Also, if necessary, protrusion parts may be formed on the front face of the diaphragm 10 (the face on the sound emission side) or the rear face (the face opposite the sound emission side). The protrusion parts can increase the rigidity of the diaphragm 10. The protrusion parts may be formed on the face of the diaphragm 10 linearly, annularly or in a lattice pattern. For example, an appropriate modifications can be made such that a plurality of linear protrusion parts may be formed on the face of the diaphragm and so forth.

The diaphragm 10 is vibratably supported at the frame 12, and if the space enclosed by the diaphragm 10 and the frame 12 in the rear side (opposite side to the sound emission direction) of the diaphragm 10 is sealed against the sound emission direction, the sound wave emitted from the rear side of the diaphragm 10 can be prevented from being emitted in the sound emission direction.

The edge 11 is disposed between the diaphragm 10 and the frame 12, and holds the diaphragm 10 at the prescribed position by the inner periphery part supporting the outer periphery part of the diaphragm 10 and the outer periphery part being connected to the frame 12. Specifically, the edge 11 vibratably supports the diaphragm 10 in the direction of the vibration (Z axial direction) and prevents the vibration in the direction orthogonal to the direction of the vibration. When viewed from the sound emission direction, the edge 11 shown in the drawing is formed in a ring shape (annular shape) and the cross-sectional shape is formed in the prescribed shape, for example, a recessed shape, a protruding shape, a corrugated shape and so forth. The edge 11 shown in the drawing is formed in a recessed shape in the sound emission direction, however it may be formed in a protruding shape in the sound emission direction. For example, the edge 11 may be formed with leather, cloth, rubber and resin, and may employ the member applying filling processing to each of these members, member molding rubber or resin in the prescribed shape and so forth.

In the example shown in the drawing, the magnetic circuit 20 of the driving part 14 forms the magnetic gap 200 in the direction orthogonal to the direction of the vibration of the diaphragm 10, however the direction of the magnetic gap 200 is not limited to the above example. The voice coil supporting part 40 has a voice coil 30 which is supported in the magnetic gap 20G, and vibrates along the magnetic gap 20G. The movement of the voice coil supporting part 40 is regulated by an after-mentioned holding part, and the movement only in the direction along the magnetic gap 20G is allowed. When an audio signal SS is inputted into the voice coil 30, a Lorentz force in the X axial direction is applied to the voice coil 30 in the magnetic gap 20G and the voice coil supporting part 40 integrally formed with the voice coil 30 vibrates in the X axial direction.

In the magnetic circuit 20 which vibrates the voice coil supporting part 40, a pair of the magnetic gaps 20G with different flux directions are disposed side by side in the direction of the vibration of the voice coil supporting part 40 in order to apply a Lorentz force in the similar direction to currents flowing through the voice coil 30 planarly wound on the voice coil supporting part 40, and the voice coil 30 is arranged so as to go around the pair of the magnetic gaps 20G.

In the example shown in the drawing, the magnetic circuit 20 are formed with magnets 21 (21A, 21B) and yoke parts 22 (22A, 22B), and a pair of the magnets 21A, 21B with magnetic poles opposite each other in the Z axial direction are disposed side by side at a predetermined interval in the X axial direction, and the aforementioned magnetic gap 20G is formed between the pair of the magnets 21A, 21B and the yoke part 22B. And, the voice coil 30 is wound such that the directions of currents flowing above the magnets 21A, 21B are opposite each other in the Y axial direction, thereby a Lorentz force is applied to the voice coil 30 in the X axial direction.

The yoke part 22 is also a static part which is disposed in the static state with respect to the voice coil 40. Further, the yoke part 22 constituting the driving part 14 includes a bottom face part 22D disposed under the magnet 21 and a side face part 22E which is formed so as to surround the bottom face part 22D. The yoke part 22 as the static part does not intend the complete static state, and, for example, the yoke part 22 may be static to the extent that it can support the diaphragm 10, and the vibration generated when a speaker device 1T is driven may be transmitted, thereby causing vibration to occur in the whole static part.

The voice coil supporting part 40 and the vibration direction converter part 50 are connected via a connecting part 60. The connecting part 60 is formed between the end part of the vibration direction converter part 50 in the side of the voice coil supporting part and the end part of the voice coil supporting part 40 in the side of the vibration direction converter part, and both the end parts are connected at the positions different in the direction of the vibration. Thus, the position of the voice coil supporting part 40 can be shifted in the direction of the height of the vibration direction converter part 50 and the height of the magnetic circuit 20 can be included in the height of the vibration direction converter part 50, thereby making it possible to have the total height further thinned. Also, the height of the vibration direction converter part 50 can be sufficiently allocated for the total height to be thinned, thereby making it possible to convert the vibration of the voice coil supporting part 40 to the vibration of the diaphragm 10 with a large vibration amplitude. In the example shown in the drawing, the voice coil supporting part 40 and the vibration direction converter part 50 are connected via the connecting part 60, however, they can also be directly connected without the connecting part 60 therebetween.

As shown in FIG. 2(b), a hinge part 52 angle-variably connects a link part 51 with respect to a connecting object, and a hinge part 52A in the side of the voice coil supporting part 40 moves in the X axial direction in response to the vibration of the voice coil supporting part 40, and a hinge part 52B in the side of the diaphragm 10 moves in the direction of the vibration of the diaphragm 10 (for example, in the Z axial direction). By forming the hinge part 52A so as to slide along the bottom face 12A of the frame 12, the vibration of the voice coil supporting part 40 can be stabilized as well as the end part of the vibration direction converter part 50 can be linearly moved, thereby the end part of the vibration direction converter part 50 connected to the diaphragm 10 can be reliably and stably moved.

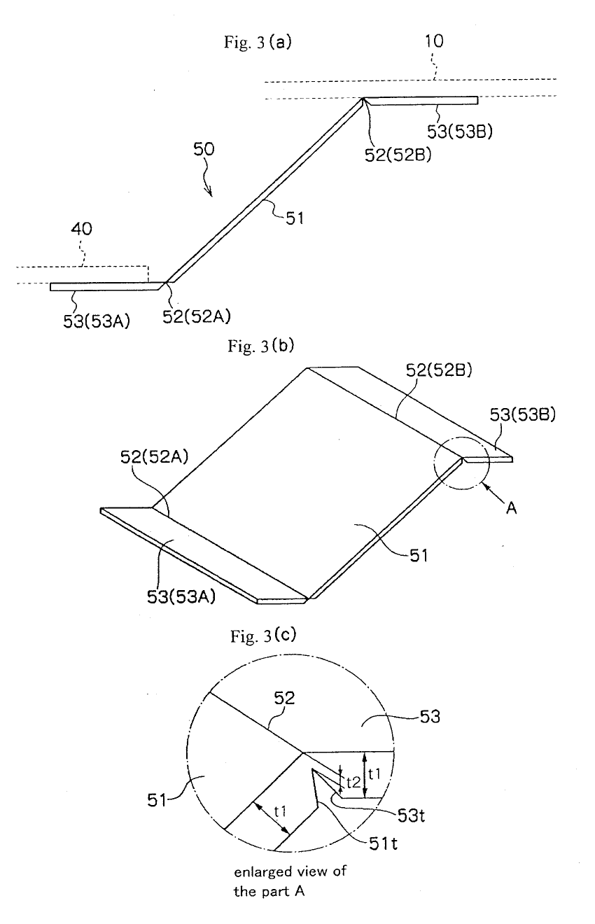

FIG. 3 is a view illustrating an example of the vibration direction converter part according to an embodiment of the present invention (FIG. 3(a) is a side view, FIG. 3(b) is a perspective view, and FIG. 3 (c) is an enlarged view of the part A in FIG. 3(b)). The vibration direction converter part 50 includes a link part 51 and hinge parts 52 (52A, 52B) formed at both ends of the link part as described above. In the example shown in the drawing, connecting parts 53 (first connecting part 53A, second connecting part 53B) are formed via the hinge parts 52 at both ends of the link part 51. Here, the first connecting part 53A is a part which is connected to the voice coil supporting part 40 and vibrates integrally with the voice coil supporting part 40, and the second connecting part 53B is a part which is connected to the diaphragm 10 and vibrates integrally with the diaphragm 10.

The vibration direction converter part 50 is integrally formed with the link part 51, the hinge parts 52A, 52B, and the first and the second connecting parts 53A, 53B, and the hinge parts 52A, 52B are formed with a bendable continuous member which continues between both side parts across the hinge parts 52A, 52B. The continuous member here may be a member which forms the whole part of the link part 51 and the first and the second connecting parts 53A, 53B, or a member which forms a part of the link part 51 and the first and the second connecting parts 53A, 53B.

If the vibration direction converter part 50 is formed with a plate shape member, the hinge part 52 is linearly formed extending in the width direction as shown in FIG. 3(b). Also, since the link part 51 is required to have undeformable rigidity while the hinge part 52 is required to be bendable, an integrally formed member is configured to have different properties by forming the thickness t2 of the hinge part 52 thinner than the thickness t1 of the link part 51 or the connecting part 53.

Further, the change in thickness between the hinge part 52 and the link part 51 is formed with a slant face shape such that the slant faces 51t, 53t, which are opposed each other, are formed at the end parts of both side parts across the hinge part 52. Thus, when the link part 51 is angle-varied, the thickness of the link part 51 is prevented from interfering with the angle variation of the link part.

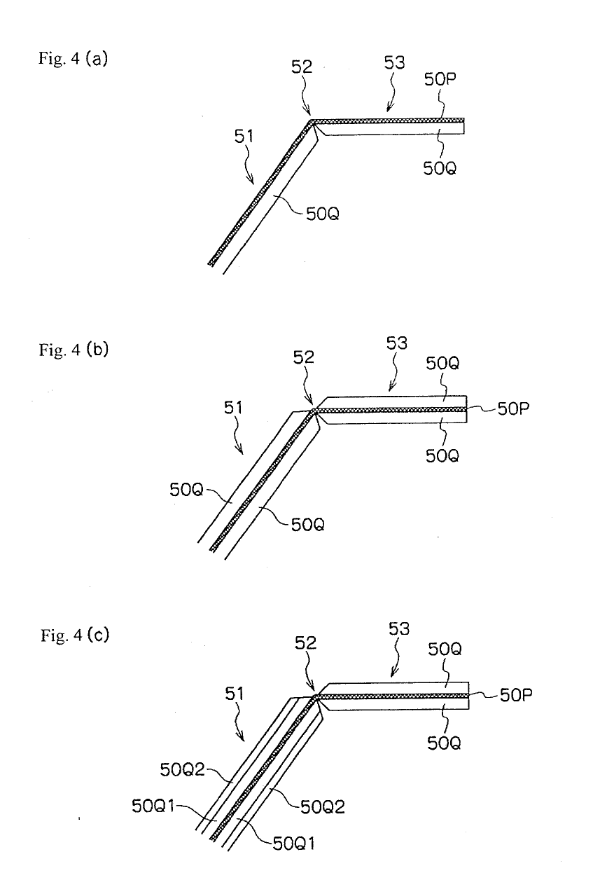

FIG. 4 is a view illustrating another example of forming the vibration direction converter part 50. Here, the bendable continuous member is integrally formed with a rigid member to form the link part or the connecting part, and the hinge part is configured as a part which is formed only with the continuous member. In the example shown in FIG. 4(a), the link part 51 or the connecting part 53 is formed by attaching the rigidity member 50Q to the face of the continuous member 50P which is a bendable sheet member. As such, the continuous member 50P continuously extends between both side parts across the hinge part 52, and the hinge part 52 is bendably formed only with the continuous member 50P. Meanwhile, the link part 51 or the connecting part 53, which is formed by attaching the rigidity member 50Q to the continuous member 50P, is configured as a part which has rigidity.

In the example shown in FIG. 4(b), the rigidity member 50Q is attached to the continuous member 50P such that the continuous member 50P is interposed between the rigidity members, thereby forming the link part 51 or the connecting part 53. Here, the part to which no rigidity member 50Q is attached becomes the hinge part 52. In the example shown in FIG. 4(c), the rigidity member forming the link part 51 is formed by accumulating the multilayer of rigidity members 50Q1, 50Q2. In FIG. 4(c), the multilayer of rigidity member 50Q1 may have substantially the same structure as the multilayer of rigidity member 50Q2. As such, by partially attaching the rigidity member 50Q to the bendable continuous member 50P, the bendable hinge part 52, the rigid link part 51 and the connecting part 53 can be integrally formed.

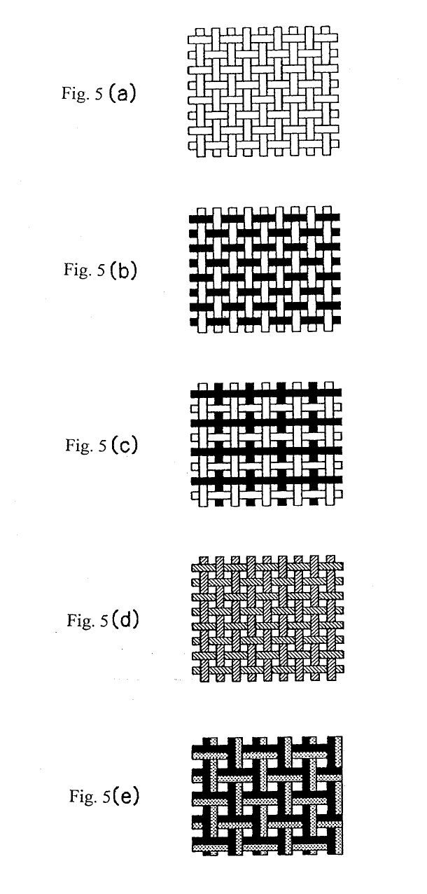

The continuous member 50P according to one or more embodiments of the present invention has strength and durability, withstanding against the bends of the hinge part 52 which are repeated in driving the speaker device, along with flexibility making little noise in repeating the bending operation. Specifically, the continuous member 50P can be formed with woven or nonwoven fabric formed with high strength fiber. As shown in FIG. 5, as examples of woven fabric, a plain weave fabric formed with a uniform material (FIG. 5(a)), a plain weave fabric with warp and weft threads formed with different materials respectively (FIG. 5(b), a plain weave fabric with alternately changed thread materials (FIG. 5(c)), a plain weave fabric with twisted union yarn (FIG. 5(d)) and a plain weave fabric by basket weaving (FIG. 5(e)), and so forth, may be included. And, a triaxial woven fabric, a multi-axial woven fabric, a triaxial and a multiaxialnon woven fabric, knit and one directional basket woven fabric, and so forth, may be included other than plain weave fabrics.

When the high strength fiber is applied partially or as a whole, sufficient strength against the vibration of the voice coil supporting parts 40 may be achieved by arranging the high strength fiber in the direction of the vibration of the voice coil supporting parts 40. When the high strength fiber is used for both the warp and the weft thread, a tensile force may be uniformly applied to the warp and the weft thread by inclining both fiber directions at 45° with respect to the direction of the vibration of the voice coil supporting parts 40, thereby durability may be improved. As the high strength fiber, aramid fiber, carbon fiber, glass fiber, and so forth may be used. Further, a damping material (damping agent, damping agent) may be coated (applied) to adjust physical properties such as bending stress or rigidity of the continuous member.

As the rigidity member 50Q, thermoplastic resin, thermosetting resin, metal, paper, and so forth, which are light-weight, easy to mold and having rigidity after hardening, may be used, according to one or more embodiments of the present invention. The vibration direction converter part 50 may be formed by attaching the rigidity member 50Q, which is molded in a plate shape, to the face of the continuous member 50P other than the part of the hinge part 52 by using adhesive. Further, if thermosetting resin is used as the rigidity member 50Q, the vibration direction converter part 50 may be formed by partially impregnating the link parts 51 or the connecting parts 53 in the fibrous continuous member 50P with resin and then hardening it. Further, if resin or metal is used as the rigidity member 50Q, the continuous member 50P and the rigidity member 50Q may be integrated at the link parts 51 and the connecting parts 53 by applying insert molding.

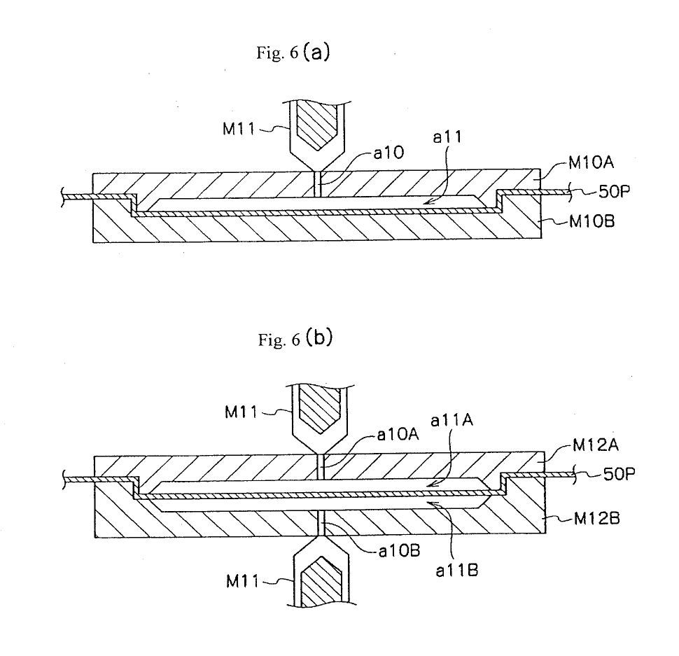

FIG. 6 is a view illustrating an example of integrally forming the continuous member 50P and a rigidity member 50Q by insert molding. The example shown in FIG. 6(a) is an example wherein the rigidity member 50Q is integrally formed in one side of the continuous member 50P. A preliminarily molded or premolded continuous member 50P is housed inside a mold M10B, being in contact with the inner face thereof, a mold M10A which has a cavity all for forming the rigidity member 50Q is fitted thereon, and an injection unit M11 is connected to an injection outlet a10 which is communicated with the cavity a11, and thus a mold material is injected into the cavity a11 to integrally mold the continuous member 50P and the rigidity member 50Q. The example shown in FIG. 6(b) is an example wherein the rigidity members 50Q are integrally formed at both faces of the continuous member 50P. A preliminarily molded or a premolded connecting member 50P is arranged at the joint face of a mold M12A and a mold M12B, the mold M12A and the mold M12B which have cavities a11A, a11B for forming the rigidity member 50Q are fitted in each other, injection units M11, M11 are connected to injection outlets a10A, a10B which are communicated with the cavities a11A, a11B, and thus a mold material is injected into the cavities a11A, a11B to integrally mold the connecting member 50P and the rigidity member 50Q.

By using these arts of insert molding, adhesive force between the continuous member 50P and the rigidity member 50Q is dramatically improved, and even if an external force of separating the rigidity member 50Q from the continuous member 50P is exerted, the separation between the continuous member and the rigidity member can be prevented, thus the reliability (long useful life) of the vibration direction converter part itself is improved. The rigidity member constituting the link part 51 or the connecting part 53 may be formed in a foam structure or non-foam structure, and the material of the rigidity member is not limited. The aforementioned arts of insert molding are described in the US application No. 20050127233 (publication No. US20051253298) filed in May 12, 2005 and the US application No. 20050128232 (publication No. US2005/253299) filed in May 13, 2005, the disclosures of which are incorporated into the present application by reference.

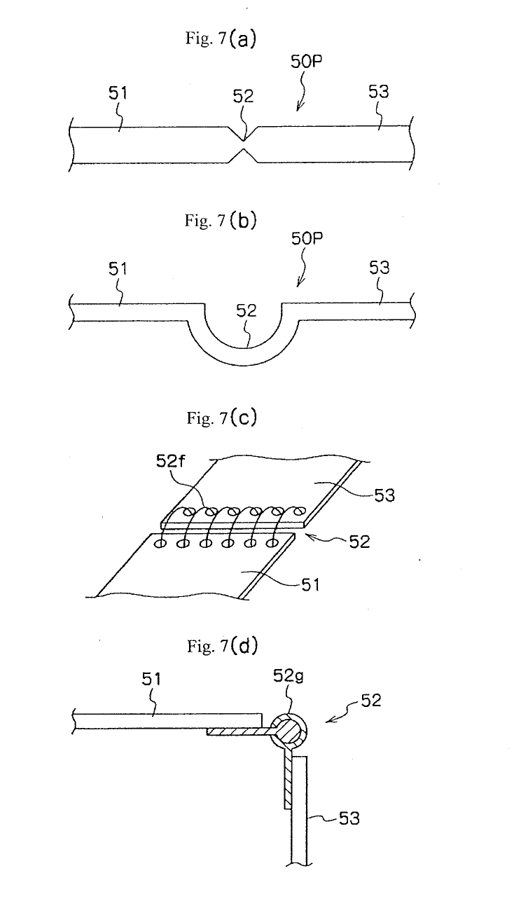

FIG. 7 is a view illustrating an example of forming the hinge part 52. In the example shown in FIG. 7(a), the hinge part 52 is formed by thinning a part of the continuous member 50P. The thick parts of the continuous member 50P are the link part 51 or the connecting part 53 and the thin part of the continuous member 50P is the hinge part 52. In the example shown in the drawing, the hinge part 52 is formed by forming a recessed part from both face sides of the continuous member 50P. In the example shown in FIG. 7(b), the hinge part 52 is formed by forming a part of the continuous member 50P in a curved shape. The linear parts of the continuous member 50P are the link part 51 or the connecting part 53, and the curved part thereof is the hinge part 52. FIGS. 7(c) and 7(d) are variations of one or more embodiments of the present invention, and in FIG. 7(c), the hinge part 52 formed between the link part 51 and the connecting part 53 or between the link parts 51 is formed by seaming with a linear member 52f. In FIG. 7(d), the hinge part 52 formed between the link part 51 and the connecting part 53 or between the link parts 51 is formed by a hinge part member 52g.

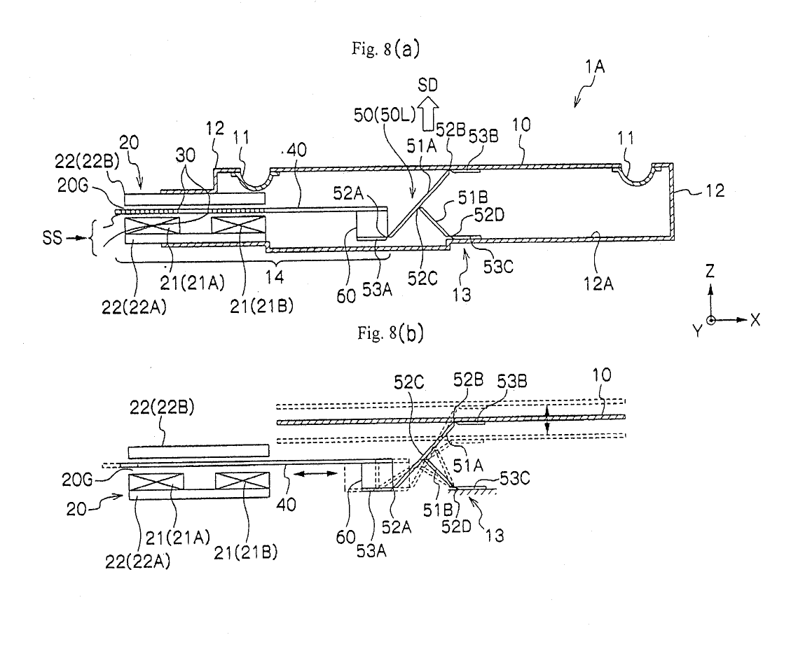

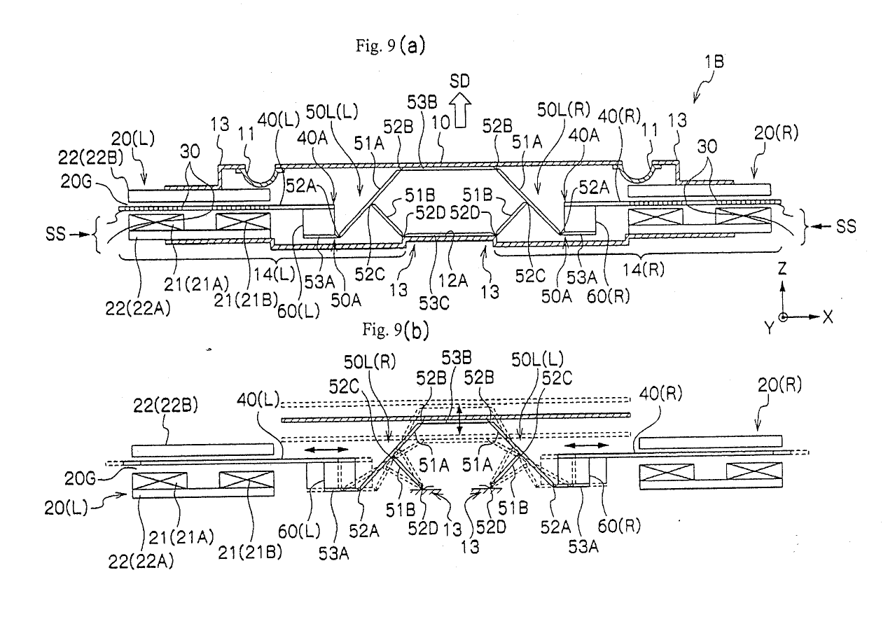

FIG. 8 and FIG. 9 are views illustrating a speaker device according to another embodiment of the present invention (FIGS. 8(a), 9(a) are cross-sectional views taken along the line in the X axial direction, and FIGS. 8(b), 9(b) are views illustrating the operation of the driving part). For the parts in common with the aforementioned descriptions, the same symbols are applied and a part of the duplicated descriptions is not repeated. In speaker devices 1A, 1B according to the embodiments shown in FIGS. 8 and 9, a link body 50L is formed such that it includes a first connecting part 53A which is connected to the voice coil supporting part 40 and vibrates integrally with the voice coil supporting part 40, a second connecting part 53B which is connected to the diaphragm 10 and vibrates integrally with the diaphragm 10, and a plurality of the link parts.

In the speaker device 1A according to the embodiment shown in FIG. 8, the vibration direction converter part 50 is formed with the link body 50L including the rigid first link part 51A and second link part 51B. The first connecting part 53A is located at one end of the first link part 51A via the hinge part 52A while the second connecting part 53B is located at another end of the first link part 51A via the hinge part 52B. The middle part of the first link part 51A is located at one end of the second link part 51B via the hinge part 52C while the connecting part 53C, which is static with respect to vibration of the voice coil support part 40, is located at another end of the second link part 51B via the hinge part 52D.

According to the example shown in the drawings, the first connecting part 53A is connected to the end of the voice coil support part 40 directly or via the connecting part 60, the second coupling part 53B is directly connected to the diaphragm 10 and the static connecting part 53C is coupled to the bottom portion 12A of the frame 12 that is the static part 13. The first link part 51A and the second link part 51B are obliquely disposed in different directions with respect to the direction of the vibration (X-axis direction) of the voice coil support part 40 and the static part 13 is provided on the opposite side of the diaphragm 10 with respect to the vibration direction converter part 50. In the example shown in the drawings, although the static part 13 is formed with the bottom portion 12A of the frame 12, a yoke 22A of a magnetic circuit 20 may be the static part 13 instead of the bottom portion 12A of the frame 12 by extending the yoke 22A of the magnetic circuit 20 to the position under the vibration direction converter part 50.

As shown in FIG. 8(b), the hinge part 52A on the side of the voice coil support part 40 moves in the X-axis direction in accordance with the movement of the voice coil support part 40 while the hinge part 52D connected to the static part 13 is fixed. The movement of the hinge part 52A is converted to the change in the angles of the first link part 51A and the second link part 51B in response to the reaction force from the static part 13, and thus the hinge part 52B on the side of the diaphragm 10 is moved in the direction of the vibration of the diaphragm 10 (for example, Z-axis direction).

The speaker device 1B according to the embodiment shown in FIG. 9 is configured with the driving parts 14 shown in FIG. 8 symmetrically disposed opposite to each other, which includes the driving parts 14(R) and 14(L), respectively. Each of the driving parts 14(R) and 14(L) includes a link body 50L(R) or 50L(L), a voice coil support part 40(R) or 40(L), a magnetic circuit 20(R) or 20(L) and a connecting part 60(R) or 60(L).

The link bodies 50L(R) and 50L(L) configure the vibration direction converter part 50 such that a pair of the first link parts 51A, a pair of the second link parts 51B, a pair of the first connecting parts 53A, the second connecting part 53B and the static connecting part 53C, which are disposed opposite to each other, are integrally formed. A pair of the first connecting parts 53A is connected to the voice coil support part 40 respectively, the second connecting part 53B is connected to the diaphragm 10, and the static connecting part 53C is connected to the bottom portion 12A of the frame 12.

As shown in FIG. 9(b), the diaphragm 10 may be driven by two combined driving forces of the driving parts 14(R) and 14(L) by setting the direction of the vibrations of the voice coil support part 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

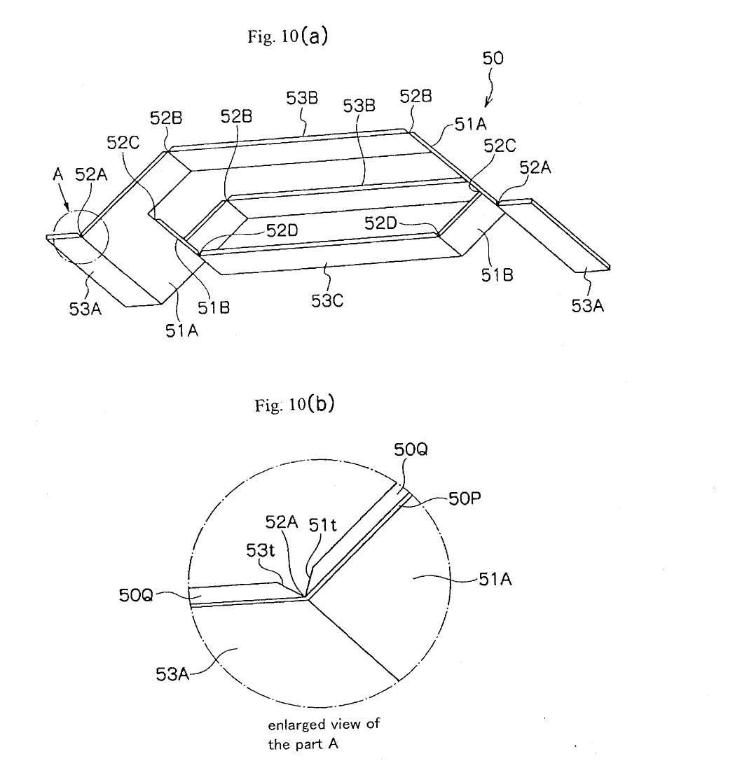

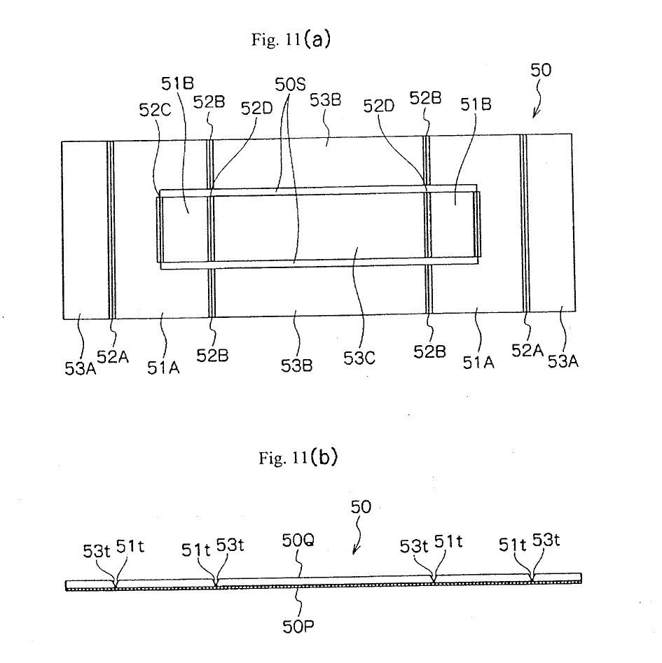

FIG. 10 and FIG. 11 are views illustrating the vibration direction converter parts used in the speaker device according to the embodiment shown in FIG. 9 (FIG. 10(a) is a perspective view, FIG. 10(b) is an enlarged view of the part A in FIG. 10(a), FIG. 11(a) is a plan view illustrating the hinge part the overall part of which is extended and flattened, and FIG. 11(b) is a side view illustrating the hinge part the overall part of which is extended and flattened). The vibration direction converter part 50 is formed with a single integrally formed component, having a pair of first link parts 51A such that hinge parts 52A and 52B are formed at both ends of the first link parts 51A and a pair of second link parts 51B such that hinge parts 52C and 52D are formed at both ends of the second link parts 51B. Further, first connecting parts 53A are formed in the side of one end part of a pair of first link parts 51A via hinge parts 52A, and a second connecting part 53B is formed between hinge parts 52B which are formed in the side of the other end parts of the pair of first link parts 51A, and a static connecting part 53C is formed between hinge parts 52D which are formed in the side of the other end part of second link parts 51B. And, the link part 51A, 51A and the second connecting part 53B are bent in a protruding shape, and the second link parts 51B, 51B and the static connecting part 53C are bent in a recessed shape.

As shown in FIG. 10(b), the hinge part 52A is bendably formed with the above continuous member 50P. The above rigid member 50Q is attached to the first link part 51A and also to the first connecting part 53A. As such, all of the above-mentioned hinge parts are formed in the similar configuration. Further, slant faces 51t and 53t are formed opposite to each other in each hinge part.

As shown in FIG. 11(a), the vibration direction converter part 50, including the link parts 51A, 51B, each hinge part and the connecting part 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are formed in a longitudinal direction of the integral sheet-shaped member such that the second link parts 51B, 51B and the static coupling part 53C are cut out and formed.

In order to form such a vibration direction converter part 50, for example, a resin member which forms the rigidity member 50Q is stacked onto the overall face of the sheet-shaped continuous member 50P and V-shaped cutout is made to form respective hinge parts and slant faces 51t, 53t at both sides thereof. Then, the aforementioned notch part 50S is formed and the resin member is hardened.

Further, each hinge part and the slant faces 51t and 53t at both sides thereof may be formed at the same time as forming the rigid member 50Q with the resin material. In one more embodiments of the present invention, a cross-sectional V-shape groove or a concave portion is formed preliminarily in a die, which is used to mold the rigid member 50Q.

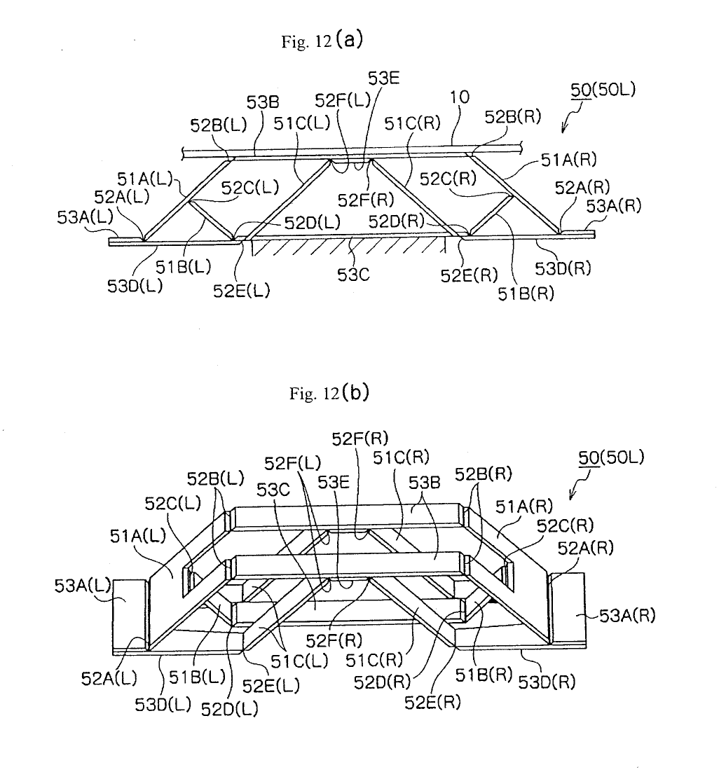

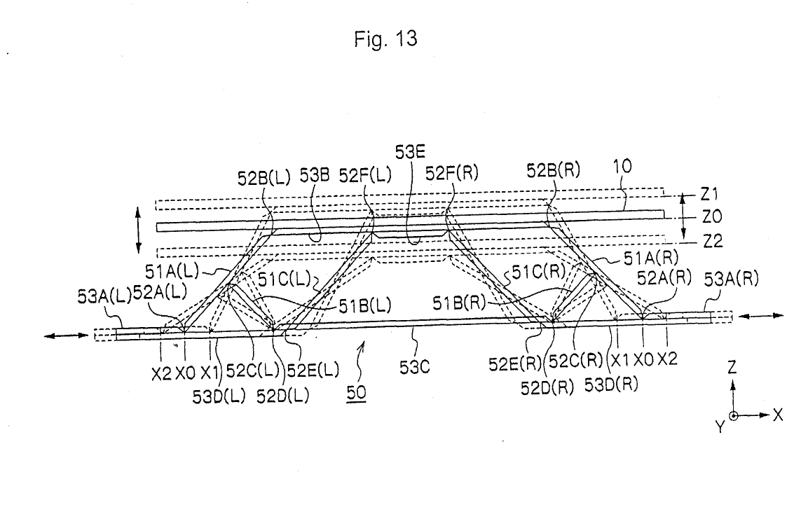

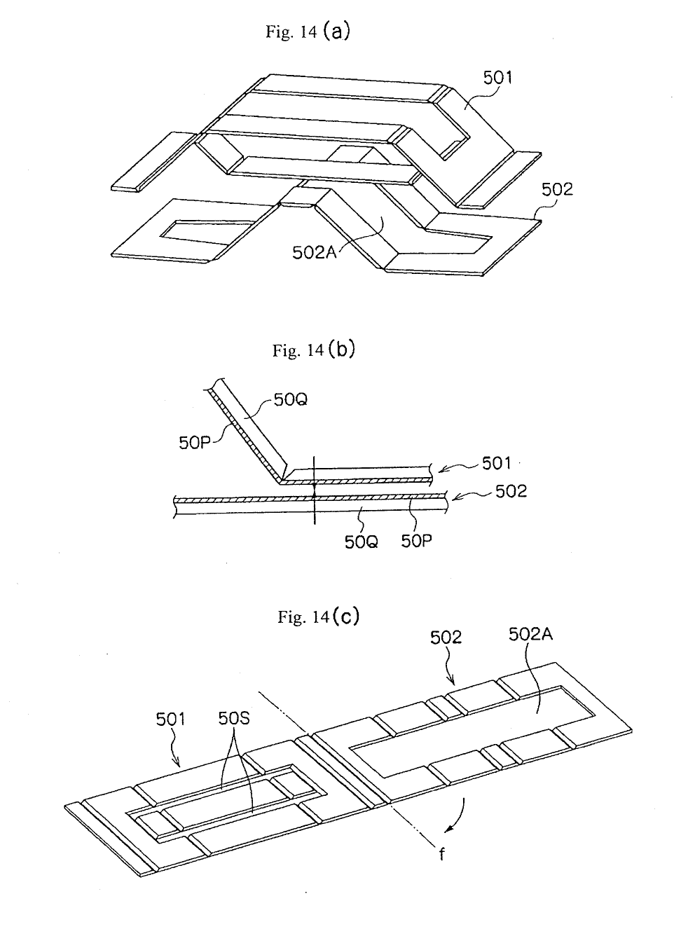

FIGS. 12, 13, 14 are views illustrating another example of the vibration direction converter part 50 according to an embodiment of the present invention (FIG. 12(a) is a side view, FIG. 12(b) is a perspective view, FIG. 13 is a view illustration the operation and FIGS. 14(a), 14(b) are views illustrating forming examples). A pair of driving parts is provided, and the vibration direction converter part 50 (link body SOL) is formed such that the vibration direction converter parts 50 are substantially symmetrically disposed in the opposite side and a parallel link is formed with a plurality of link parts.

The vibration direction converter part 50 according to this embodiment includes a pair of first link parts 51A(R) and 51A(L) having a hinge part 52A(R) and 52A(L) to a first connecting part 53A (R) and 53A (L) at one end, and having a hinge part 52B(R) and 52B(L) to a second connecting part 53B at another end. Also, the vibration direction converter part 50 includes a pair of second link parts 51B(R) and 51B(L) having hinge parts 52C(R) and 52C(L) to the middle parts of the first link parts 51A(R) and 51A(L) at one end, and having hinge parts 52D(R) and 52D(L) to the static connecting part 53C at another end. As described above, the first connecting part 53A is connected to the voice coil support part 40 directly or via the connecting part 60 as other member, while the second connecting part 53B is connected to the diaphragm 10 and the static connecting part 53C is connected to the bottom portion 12A of the frame 12 that is the static part 100, the yoke 22, etc. forming the magnetic circuit 20.

Further the vibration direction converter part 50 includes a pair of third link parts 51C(R) and 51C(L) having hinge parts 52E(R) and 52E(L) at one end to a pair of the connecting parts 53D(R) and 53D(L) integrally extending from the first connecting part 53A (R) and 53A (L), and having hinge parts 52F (R) and 52F (L) at another end to a connecting part 53E that is integral with the second connecting part 53B.

Further, the first link part 51A(R) and the third link part 51C(R), the first link part 51A(L) and the third link part 51C(L), the second link part 51B(R) and the third link part 51C(L), and the second link part 51B(L) and the third link part 51C(R) form parallel links respectively.

The link body 50L of this vibration direction converter part 50 substantially has a function of the combination with the link body of the embodiment shown in FIG. 8 and the parallel link body, and each of the link parts and the connecting parts are formed by integrating the rigidity member 50Q to the continuous member 50P, and each hinge part between the link parts is linearly formed only with the bendable continuous member 50P, and thus the link parts are integrally formed via hinge parts therebetween.

An operation of the vibration direction converter part 50 is described with reference to FIG. 13. In this embodiment, the static connecting part 53C functions as the static part. According to the vibration direction converter part 50, when the hinge parts 52A(R) and 52A(L) is moved from the reference position X0 to X1 in the X-axis direction in accordance with vibration of the voice coil support part 40, the second connecting part 53B and the connecting part 53E integrally with the second connecting part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D(R) and 52D(L) are supported at both ends of the static connecting part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X-axis direction, the second connecting part 53B and the connecting part 53E integrally with the second connecting part 53B are moved down keeping a parallel state by the parallel link body, while angles of the first link parts 51A(R) and 51A(L) and the third link parts 51C(R) and 51C(L), which configure a parallel link, are varied as they are laid. Since the hinge parts 52D(R) and 52D(L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this embodiment, the vibration of one voice coil supporting part 40 in the X axial direction is converted to the vibration in the Z axial direction of the hinge parts 52B (R), (L), 52F(R), (L) and the second connecting part 53B, which vibrate substantially in the same phase and substantially with the same vibration amplitude. Thus, the diaphragm 10 is supported at broad area and the vibration in substantially the same phase and with the same vibration amplitude is transmitted to the diaphragm 10, thereby transmitting the vibration of the voice coil supporting part 40 substantially in the same phase to the planar diaphragm 10 which has a broad area.

As shown in FIG. 12 (b), in the vibration direction converter part 50, a pair of the connecting parts 53B, 53D(R) and 53D(L) and the third link parts 51C(R) and 51C(L) are disposed in a width direction and parallel respectively. The first link parts 51A(R) and 51A(L) are formed in a biforked shape, and the hinge parts 52C(R) and 52C(L) to the second link parts 51B(R) and 51B(L) are formed at the middle parts of the first link parts 51A(R) and 51A(L). The second link parts 51B(R) and 51B(L) and the connecting part 53C are placed between a pair of the connecting parts 53B, 53D(R) and 53D(L) and the third link parts 51C(R) and 51C(L), which are disposed in a width direction and parallel.

With link parts configured with a single sheet-shape component as described above, the diaphragm 10 can be vibrated and supported by a face, and thereby the whole diaphragm 10 can be vibrated substantially in the same phase and divided vibration may be restrained.

Further, as shown in FIG. 12(b), in the vibration direction conversion part 50 of this embodiment, the first link parts 51A(R) and 51A(L), and the second connecting parts 53B are configured by folding the whole single sheet-shape component forming the link parts in a protruding-trapezoid shape, while the second link parts 51B(R) and 51B(L), and the static connecting part 53C are configured by folding in a recessed-trapezoid shape and in a partially taken-out portion of this plate component.

A method of configuring this vibration direction converter part 50 is described with reference to FIG. 14. According to one configuration method, this vibration direction converter part 50 is formed by joining a plurality of sheet-shape components 501, 502 (for example, two components) as shown in FIG. 14(a). The first connecting parts 53A(R) and 53A(L), the first link parts 51A(R) and 51A(L), the second link parts 51B(R) and 51B(L), the second connecting parts 53B and the static connecting part 53C are formed in one sheet-shape component 501, while the connecting parts 53D, the third link parts 51C(R) and 51C(L) and the connecting parts 53E are formed in another sheet-shape component 502. And, the third link parts 51C(R) and 51C(L) and the connecting parts 53D(R) and 53D(L) are formed along the first link parts 51A(R) and 51A(L) and the second connecting parts 53B, and an opening 502A is formed in the sheet-shape component 502 corresponding to the second link parts 51B(R) and 51B(L) and the static connecting part 53C.

In this example, the opening 502A, formed in another sheet-shape component 502 corresponding to the second link parts 51B(R) and 51B(L) and the static connecting part 53C of one sheet-shape component 501, is formed so as to expand inward from ends of another sheet-shape component 502. This configuration may prevent the second link parts 51B(R) and 51B(L), and the static connecting part 53C from contacting another sheet-shape component 502, and thus a smooth movement of the link body may be performed.

The two sheet-shape components 501 and 502, which are formed with the continuous member 50P and the rigid member 50Q, are applied with their continuous members 50P, 50P face-to-face as shown in FIG. 13(b). According to this arrangement, the continuous members 50P, 50P are integrated, and thereby hinge parts 52 may smoothly bend.

Further, the slant face as shown in FIG. 3(c) is formed at the end of each link part in vicinity of each hinge part. The slant face is formed such that the link parts do not interfere with each other when they bend at the hinge parts. Thus the link parts can efficiently bend at the hinge parts.

In another configuration example, the above-mentioned sheet-shape component 501 and the sheet-shape component 502 are integrally formed with the sheet-shape component 502 connected to the end of the sheet-shape component 501 as shown in FIG. 14(c). The vibration direction converter parts 50 shown in FIGS. 12 and 13 may be obtained by folding the integrated components along a folding line f in the direction of an arrow. In this example, the vibration direction converter part 50 may be simply configured by applying resin material forming the rigid member 50Q to the whole surface of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 12.

Further, when forming each hinge part and the slant faces 51t and 53t at the both sides of the hinge part, the rigid member 50Q may be formed with the resin material and molded at the same time. According to one or more embodiments of the present invention, a cross-sectional V-shape groove or a recessed portion is preliminarily formed in a die, which is used to mold the rigid member 50Q.

In the embodiment shown in FIGS. 9 to 14, since the link body of the vibration direction converter part can be formed by attaching a single integrally formed component with respect to the two opposing voice coil supporting parts 40, assembly can be easily made when forming a speaker device including a pair of driving parts. Also, by providing the static connecting part 53C, the positions of the hinge parts 52D(R), (L) can be kept constant with respect to the opposite vibration of the voice coil supporting parts 40 (a plurality of the voice coil supporting parts 40 oppositely vibrate to each other) without particularly supporting the hinge parts 52D(R), (L) at the frame 12, whereby the vibration direction converter part can be simply incorporated into the speaker device.

And, in the embodiments shown in FIGS. 12 to 14, since a parallel link is formed with the first link part 51A(R) and the third link part 51C(R) in the right side, and the first link part 51A(L) and the third link part 51C(L) in the left side as a link body, the second connecting part 53B which is fixed to the diaphragm 10 can be stably parallel moved in the Z axial direction with respect to the opposite vibration of the voice coil supporting parts 40. Thus, it is possible to apply a stable vibration to the planar diaphragm 10.

In the speaker devices 1, 1A and 1B according to an embodiment of the present invention, when an audio signal SS is inputted, the voice coil supporting part 40 vibrates along the magnetic gap 20G which is formed in the different direction from the direction of the vibration which is allowed for the diaphragm 10, and the vibration is direction-converted by the vibration direction converter part 50 and is transmitted to the diaphragm 10, thereby the diaphragm 10 is vibrated and sound is emitted in the sound emission direction corresponding to the audio signal SS.

Since the direction of the magnetic gap 20G is crossed by the direction of the vibration of the diaphragm 10 and the thickness direction of the speaker devices 1, 1A and 1B, the increase of the driving force of the magnetic circuit 20 or the vibration stroke of the voice coil supporting part 40 has little effect on the size in the thickness direction (Z axial direction) of the speaker devices 1, 1A and 1B. Thus, the speaker devices 1, 1A and 1B can be made thin while pursuing loud sound.

Further, since the vibration direction converter part 50 converts the direction of the vibration of the voice coil support part 40 and transmits the vibration to the diaphragm 10 through the mechanical link body, transmission efficiency of vibration is high. In particular, in the speaker devices 1A, 1B shown in FIGS. 3 to 4, since angle variation of the first link parts 51A and the second link parts 51B is produced by the vibration of the voice coil support part 40 and reaction force of the static part 13, vibration of the voice coil support part 40 may be more securely transmitted to the diaphragm 10. Accordingly, the speaker devices 1A, 1B may produce preferable reproducing efficiency.

Also, by providing the connecting part 60, difference in height can be formed between the position of the end part of the voice coil supporting part 40 and the position of the end part 50A of the vibration direction converter part 50. Thus, the width (height) of the Z axial direction of the magnetic circuit 20 can be covered within the height of the vibration direction converter part 50, thereby the speaker device 1 to 1B can be made thin while keeping the sufficient height of the magnetic circuit 20 which is necessary to secure a driving force. Also, by providing the connecting part 60, even if the speaker devices 1 to 1B can be made thin, the necessary height of the vibration direction converter part 50 (the length of the link part 51) can be secured, thereby large amplitude of the diaphragm 10 can be obtained.

Further, since the bottom face 61 of the connecting part 60 is formed so as to slide over the bottom face 12A of the frame 12 or the static part 13, the vibration of the voice coil supporting part 40 can be stabilized, the end part of the vibration direction converter part 50 can be linearly moved, and the end part 50B of the vibration direction converter part 50, which is connected to the diaphragm 10, can be securely and stably moved.

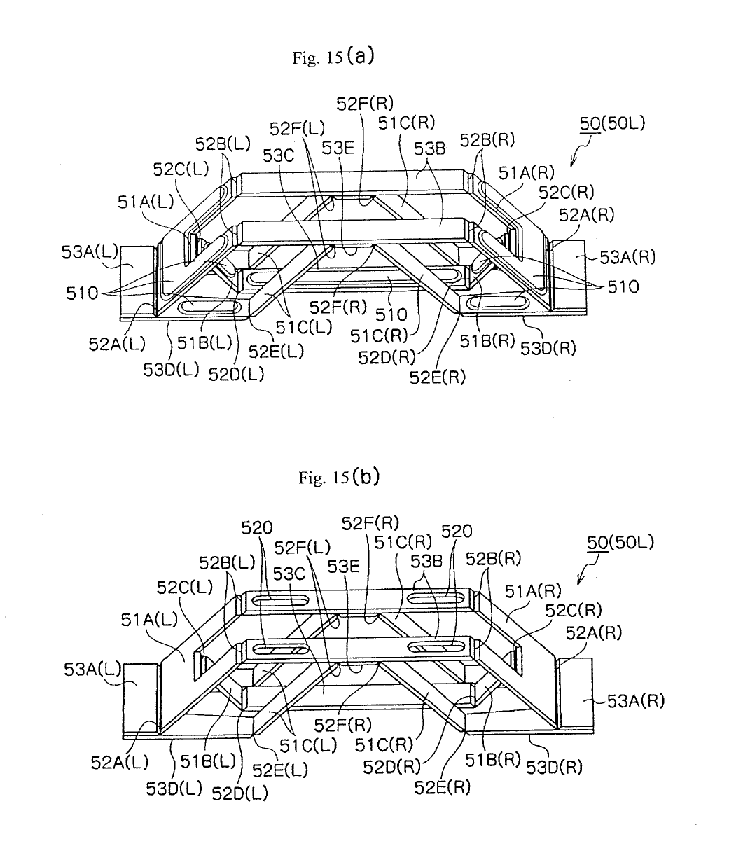

The embodiment shown in FIG. 15 is an example of improvement of the embodiment shown in FIG. 12. In the example shown in FIG. 15(a), a protruding part 510 is provided to increase rigidity of the link part which is subjected to bend due to the opposite vibration of the voice coil supporting part 40. In the example shown in the drawing, the protruding parts is provided at each of the first link parts 51A(R), (L), the second link parts 51B(R), (L), the connecting parts 53D(R), (L), and the connecting part 53C respectively. Further, in the example shown in FIG. 15(b), the vibration direction converter part is weight-reduced by providing an opening 520 at the link part which particularly do not require strength. In the example shown in the drawing, the openings 520 are provided at the connecting part 53B. The weight-reduction of the vibration direction converter part is effective in particular for broadening reproduction property or increasing vibration amplitude of sound wave and sound pressure level for predetermined voice currents.

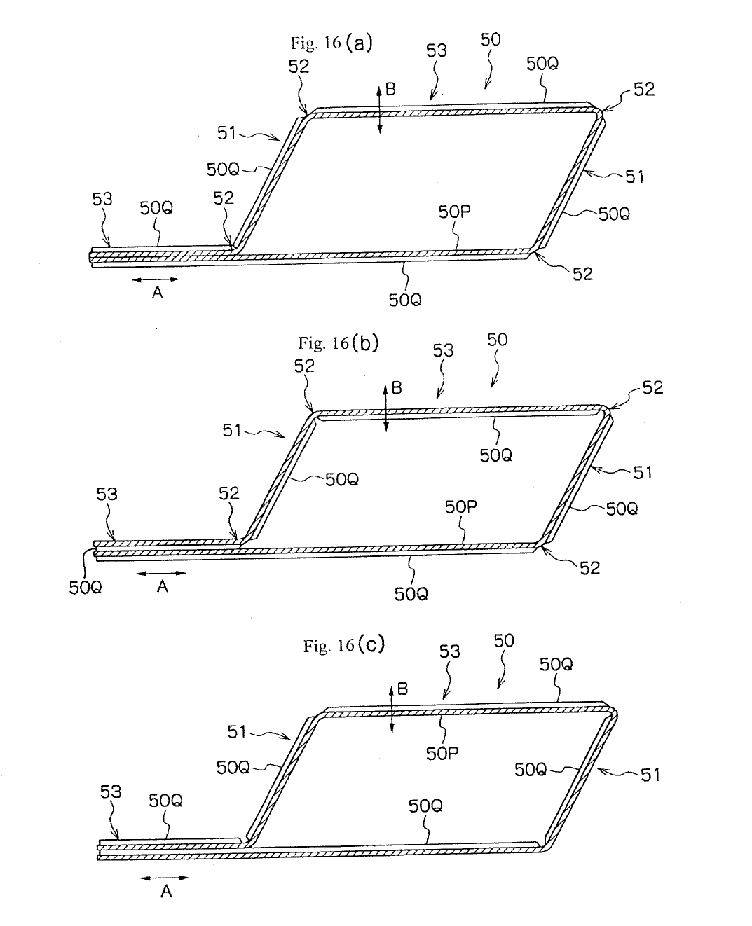

FIG. 16 shows a variation of the vibration direction converter part 50. The vibration direction converter part 50 includes a pair of hinge parts 52 which are adjacently arranged each other in the direction of the vibration of the voice coil (arrow A direction) and a straight line connecting the pair of hinge parts 52 is substantially in parallel with the direction of the vibration of the voice coil (arrow A direction). The link body of this vibration direction converter part 50 includes at least four hinge parts 52, and the link parts 51 and the connecting parts 53 between the four hinge parts form a parallelogram and the hinge parts 52 are disposed near the corners of the parallelogram.

In the example shown in FIG. 16(a), a pair of hinge parts 52 is arranged at the same face side of the rigidity member 50Q. Also, all the hinge parts 52 are formed inside the rigidity member 50Q. However, not limited to this, the hinge parts 52 can be formed outside the rigidity member 50Q. As such, owing to the continuous member 50P, the parallelogram can be easily formed, and the hinge parts 52, which are formed with the continuous member 50P, are arranged at the corners of the parallelogram, thereby a parallel link can be formed so as to smoothly move.

In contrast, in FIGS. 16(b), 16(c), the hinge parts 52 are formed inside or outside the rigidity member 50Q. As such, when the continuous member 50P is connected, the rigidity member 50Q may be provided between the continuous members 50P, and the length of the rigidity member 50Q is required to be adjusted in order to accurately form the parallelogram with the continuous member 50P.

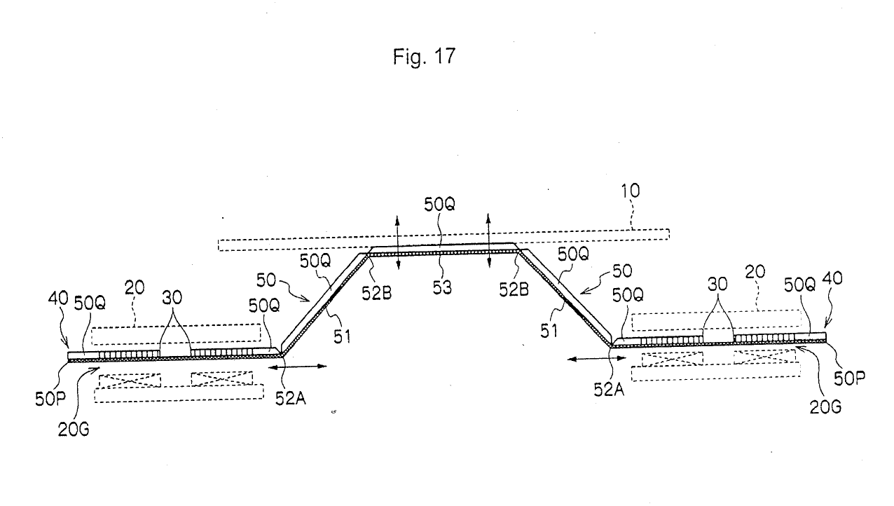

FIG. 17 is a view illustrating a speaker device according to another embodiment of the present invention. In this embodiment, the vibration direction converter part 50 and the voice coil supporting part 40 are integrally formed, and the link part 51 of the vibration direction converter part 50 and the voice coil supporting part 40 are formed such that the continuous member 50P and the rigidity member 50Q are laminated, and in the voice coil supporting part 40, the voice coil 30 is supported inside the rigidity member 50Q or on the face of the rigidity member 50Q.

As shown in the drawing, when a pair of driving parts is oppositely disposed, the continuous member 50P is continuously extended from one side voice coil supporting part 40 to other side voice coil supporting part 40 via link part 51 of one side of the vibration direction converter part 50, the connecting part 53 to the diaphragm 10, and the link part 51 of other side of the vibration direction converter part 50. And, rigidity member 50Q is integrally stacked to the face of the continuous member 50P except for the hinge parts 52A, 52A between the voice coil supporting parts 40 and the link parts 51, and the hinge parts 52B, 52B between the link parts 51 and the connecting parts 53, and the voice coil 30 is supported inside or on the face of the rigidity member 50Q in the voice coil supporting part 40 which is disposed in the magnetic gap 20G of the magnetic circuit 20.

In such an embodiment, by integrally forming the voice coil supporting part 40 and the vibration direction converter part 50, assembly of components in the speaker device can be simplified. Also, by integrating the vibration transmission system, vibration transmission efficiency can be improved, thereby the vibration of voice coil supporting part 40 can be securely transmitted to the diaphragm 10.

Hereinafter, the details of the speaker device according to an embodiment of the present invention are more specifically described.

### [Holding Part (Damper) 15]

The holding part 15 holds the voice coil supporting parts 40 at a prescribed position in the magnetic gap 20G such that the voice coil supporting part 40 does not contact the magnetic circuit 20 and linearly vibrates in the direction of the vibration (X-axis direction). This holding part 15 restricts the voice coil supporting parts 40 not to move in directions, for example, Z-axis direction or Y-axis direction different from the direction of the vibration of the voice coil supporting parts 40.

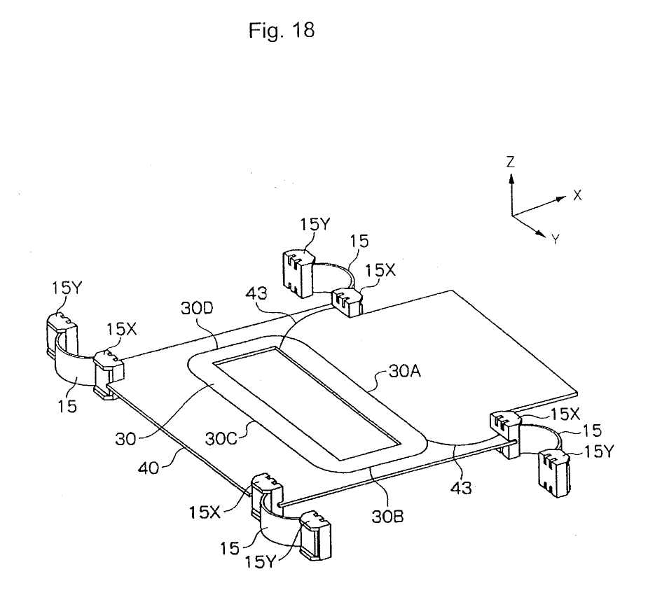

FIG. 18 is a view illustrating a specific example of the holding body in the voice coil supporting part 40 using a holding part 15. The holding part 15, for example, is made of conducting metal, and is electrically connected to the end part of the voice coils 30 or a voice coil lead wire 43 extending from the end part at one end part on the side of the voice coil supporting part 40, and is electrically connected to an audio signal input terminal at another end part in the side of the frame. As described above, the holding part 15 itself may be vibration wiring made of conducting metal, or the holding part 15 may be a wiring substrate (for example, wiring linearly formed on the substrate). The voice coils 30 are planarly formed substantially in a rectangular shape, including linear portions 30A and 30C formed in the Y axial direction and linear portions 30B and 30D formed in the X axial direction. The linear portions 30A and 30C of the voice coils 30 are arranged in the magnetic gaps 20G of the magnetic circuit 20 and the direction of the magnetic field is prescribed to be in the Z axial direction.

In the example shown in the drawings, the holding part 15 is a curved plate member, which allows deformation in one direction along the direction of the vibration of the voice coil supporting parts 40, restricts deformation in other directions, and holds the voice coil supporting parts 40 substantially symmetrically. In the example shown in FIG. 18, both end parts of the holding part 15, one end part of the holding part 15 is attached to the voice coil supporting part 40 via the connecting part 15X while the other end part is attached to the frame via the connecting part 15Y. The connecting parts 15X and 15Y are made of an insulating body such as resin, and the voice coil lead wire 43 extending from the voice coil 30 is electrically connected to the holding part 15 by soldering and so forth, and the holding part 15 is electrically connected to the audio signal input terminal.

Further, this connecting parts 15X and 15Y may form electrical connecting terminals, and the connecting part 15X may be connected to the end part of the voice coils 30 or the voice coil lead wire 43 extending from the end part, and the connecting part 15Y may be electrically connected to the audio signal input terminal.

Since the lead wire used in the conventional speaker device causes vibration when driving the speaker device, the lead wire need to be wired in a predetermined space so as not to contact the members configuring the speaker device, for example, the frame. This is one of the obstacles to prevent the speaker device from being made thin. However, with the lead wire 43 being formed on the voice coil supporting parts 40 as in the example shown in FIG. 18, predetermined space is no more required to wire the voice coil lead wire 43, and thereby the speaker device may be made thin.

The other end part of the holding part 15 is attached to the connecting part 15Y, and the connecting part 15Y supports the holding part 15 at the frame such that the voice coil supporting part 40 vibrates basically in the X axial direction. Further, with the voice coil lead wire 43, extending to the conductive holding part 15 and electrically connected thereto, disconnection between the voice coil lead wire 43 and the holding part 15 is prevented, thus reliability of the speaker device may be improved.

The holding part 51, which is a curved plate member and is made of conducting metal, allows the move of the voice coil support parts 40 in the X axial direction due to deformation of the holding part 15, while regulating the move in the Z-axis direction due to high rigidity of the curved plate member. Accordingly, the voice coil supporting part 40 constantly maintains a predetermined height with respect to the frame in the Z axial direction. Further, by providing the holding part 15 substantially symmetrically, the voice coil support part 40 is balanced in the movement in the Y-axis direction based on an elastic force of the holding part 15, and thus the voice coil support part 40 is maintained at a predetermined position with respect to the frame in the Y-axis direction.

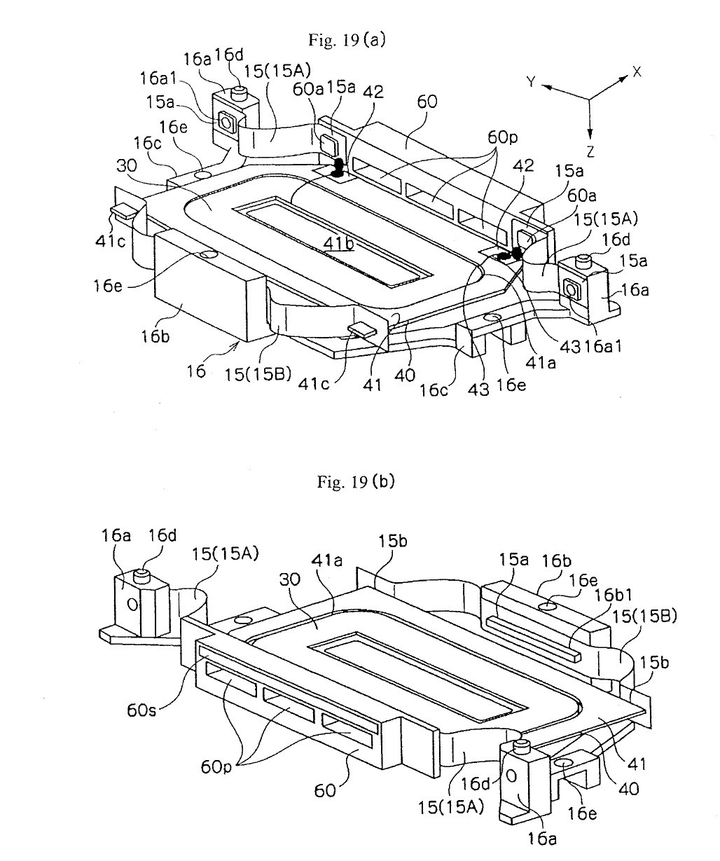

FIG. 19 is a view illustrating a voice coil supporting part, a connecting part, a holding part and an attachment unit (FIG. 19(a) is a perspective view which is viewed from the intermediate direction between the X axial direction and the Y axial direction and FIG. 19(b) is a perspective view which is viewed from the direction opposite the direction shown in FIG. 19(a)). Here, a specific configuration is shown, illustrating the voice coil supporting part 40 and the connecting part 60 which are held at or attached to the frame directly or via other members.

In the voice coil supporting part 40, the connecting part 60 is attached to one end of the voice coil supporting part in the direction of the vibration, and the connecting part 60 is attached as extending along the width of the voice coil supporting part 40. In the voice coil supporting part 40, a voice coil mounting place 41a is formed at a tabular insulating plate 41 and the voice coil 30 is attached at the voice coil mounting place 41a. An opening 41b is formed inside the voice coil 30 on the voice coil supporting part 40, thereby the voice coil supporting part 40 is weight-reduced.

A connecting hole 60s into which a first connecting part 53A of the vibration direction converter part 50 is connected and a through-hole 60p penetrating in the direction of the vibration of the voice coil supporting part 40 are formed at the connecting part 60. The through-hole 60p is a through-hole which is formed to prevent the connecting part 60 from being a resistance with respect to the vibration of the voice coil supporting part 40.

The voice coil supporting part 40 and the connecting part 60 are held at the frame with the holding part 15 directly or via other members. The holding part 15 is configured to allow the voice coil supporting part 40 to move in the X axial direction while regulating the voice coil supporting part 40 to move in other directions. Specifically, a plate member with the thickness in the Z axial direction has a protruding curve formed in the X axial direction, allowing deformation associated with bending and stretching direction while regulating other deformations.

One end part of the holding part 15 is connected to the voice coil supporting part 40 or the connecting part 60 and the other end part of the holding part 15 is connected to the attachment unit 16 or the middle part is connected to the voice coil supporting part 40 or the connecting part 60, and both end parts of the holding part 15 are connected to the attachment unit 16. The voice coil supporting part 40 or the connecting part 60 is held at the frame via the attachment unit 16.

In the example shown in the drawing, the holding part 15 includes a first holding part 15A and a second holding part 15B, and the first holding part 15A and the second holding part 15B hold the voice coil supporting part 40 at the frame 12 via the attachment unit 16. The first holding part 15A holds the connecting part 60 at the attachment unit 16, and the inner side end parts of the first holding part 15A which are respectively provided at right and left sides are connected to both outer side end parts of the connecting part 60, and each of the outer side end parts of the first holding part 15A is connected to the attachment unit 16 respectively. More specifically, at both outer side end parts of the connecting part 60, engaging protrusions 60a, 60a are formed, and at inner side end part of the first holding part 15A, engaging holes 15a, 15a are formed so as to engage with the engaging protrusion 60a, 60a. First connecting parts 16a, 16a of the attachment unit 16 are formed at both sides of the connecting part 60 and engaging holes 15a are formed at the outer side end parts of the first holding part 15A so as to engage with the engaging protrusions 16a1, 16a1 of the first connecting parts 16a, 16a.

In the example shown in the drawing, the center part of one member of the second holding part 15B is connected to the second connecting part 16b of the attachment unit 16, and both end parts of the second connecting part 16b are connected to the right and left end parts of the voice coil supporting part 40. An engaging protrusion 16b1 is formed at the second connecting part 16b, and the engaging hole 15b of the second holding part 15B engages with the engaging protrusion 16b1. Engaging protrusions 41c, 41c are formed at the right and left end parts of the voice coil supporting part 40, and engaging holes 15b, which are formed at both end parts of the second holding part 15B, engage with the engaging protrusions 41c, 41c. Here, the second holding part 15B is arranged within the width of the voice coil supporting part 40 such that the holding body of the voice coil supporting part 40 does not take up in the width direction of the voice coil supporting part 40. In the case where sufficient space is available, the second connecting parts 16b are arranged at right and left sides as well as the first connecting parts 16a, thereby the right and left end parts of the voice coil supporting part 40 may be connected to the right and left second connecting parts 16b respectively via the second holding part 15B.

The attachment unit 16 has an integrally supporting part 16c which integrally supports the first connecting parts 16a and the second connecting parts 16b, such that the first connecting parts 16a to which the end part of the first holding part 15A is connected, are provided at both sides of the connecting part 60, and the second connecting part 16b, to which the second holding part 15B is connected, is provided at the rear side of the voice coil supporting part 40. Further, the attachment unit 16 includes an attachment engaging part 16d and an attachment engaging hole 16e attached to the frame 12, and the voice coil supporting part 40, the connecting part 60. By uniting the holding part 15 (first holding part 15A, second holding part 15B) and the attachment unit 16, it is possible to incorporate the holding part and the attachment unit into the frame 12 with a single attachment step.

Also, in one or more of the embodiments described above, the first connecting part 16a of the attachment unit 16 can be configured to act as an audio signal input terminal such that an audio signal is supplied to the voice coil 30 via the first holding part 15A. In this case, a signal line may be provided along the first holding part 15A, the first holding part 15 maybe formed as a flexible wiring board, or the first holding part 15A may be formed with an electrically conductive material to make itself a signal line. And, the voice coil conductive line 43 from the voice coil 30 is formed on the tabular insulating plate 41, the end part of the voice coil conductive line 43 is electrically connected to the voice coil connecting terminal 42, and the voice coil connecting terminal 42 is electrically connected to the signal line terminal of the first holding part 15A.

By forming an input signal transmission path for the audio signal, wiring space for input signal lines can be saved, thereby space efficiency within the device can be improved. Further, the signal lines do not largely move even when the voice coil supporting part 40 vibrates, and thus the trouble of making abnormal noise caused by the signal lines contacting with each part in the device can be prevented.

### [Magnetic Circuit 20]

In one or more of the embodiments described above, the magnetic circuit 20 has a pair of magnets 21A, 21B which have opposite magnetic poles to each other in the Z axial direction and are disposed side by side with a predetermined interval in the X axial direction, and the aforementioned magnetic gap 20G is formed between the pair of magnets 21A, 21B and the yoke part 22B. And the voice coil 30 is wired such that the currents following above the magnets 21A, 21B oppositely flow in the Y axial direction, thereby a Lorentz force exerts on the voice coil 30 in the X axial direction.

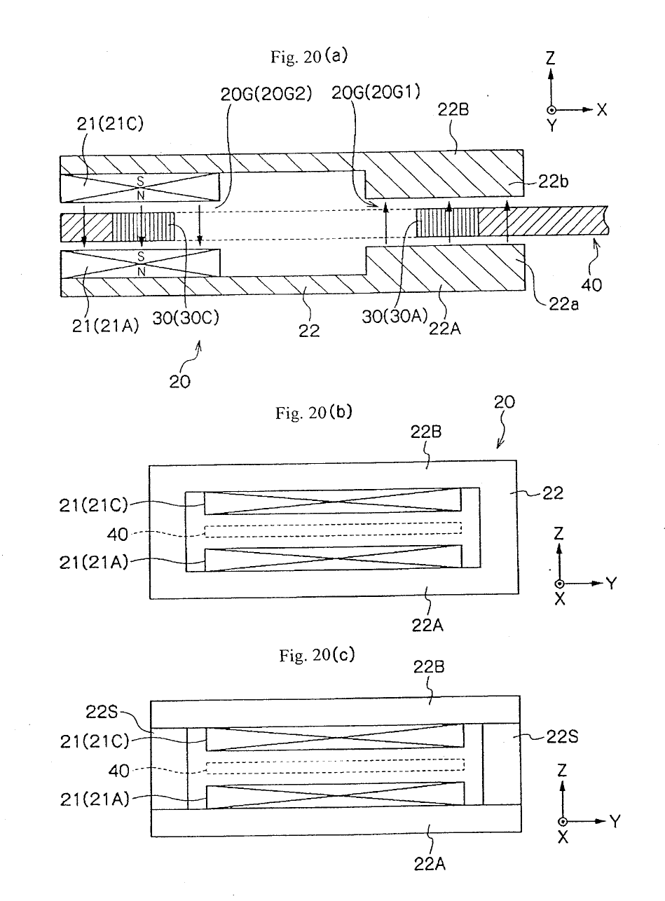

The magnetic circuit 20 can be formed so as to have the similar function as those described above even if the placement of the magnet 21 and the yoke part 22 is changed. In the example shown in FIG. 20, the magnet 21A and the magnet 21C are magnetized in the similar direction such that the direction of the magnetic field applied to the linear part 30A of the voice coil 30 is opposite to the direction of the magnetic field applied to the linear part 30C, and the magnetic gap 20G2 is formed between the magnet 21A and the magnet 21C, and the magnetic gap 20G1 is formed between the yoke protruding parts 22a, 22b which are formed at the yoke parts 22A, 22B respectively.

Although the magnetization of the magnet 21 can be performed after connecting the magnet 21 and the yoke part 22, the step of the magnetization is required to repeat two times in one or more of the aforementioned embodiments. In contrast, in the example shown in FIG. 20, it is enough to magnetize in the similar direction the magnets 21A, 21C which form the magnetic gap 20G2, therefore the step of magnetization which is performed after connecting the magnet 21 and the yoke 22 can be done at one time, thus the step can be simplified.

A pair of yoke parts 22A, 22B, which are disposed at both sides of the magnetic gap 20G and to which the magnets 21A, 21C are connected respectively, has the end parts which are connected, for example, as shown in FIG. 20(b), so as to surround the moving space of the voice coil supporting part 40. As such, the upper and lower yoke parts 22A, 22B are magnetically coupled, whereby the magnetic flux density in the magnetic gap 20G can be more increased.

Also, the pair of yoke parts 22A, 22B, which are disposed at both sides of the magnetic gap 20G and to which the magnets 21A, 21C are connected respectively, for example, as shown in FIG. 20(c), can have the end parts supported by a nonmagnetic spacer 22S. As such, the upper and lower yoke parts 22A, 22B are stably supported such that the interval of the magnetic gap 20G can be kept constant.

### [Specific Example of Vibration Direction Converter Part]

The rigidity member 50Q, which forms the vibration direction converter part 50, according to one or more embodiments of the present invention, is made from a resin material which has high environment resistance properties such as lightweight, high rigidity, low internal loss, high adhesion to continuous member 50P, lower contractility due to heat and so forth. The thermoplastic resin which can be used here, includes olefin-system resin such as polyethylene, polypropylene and so forth, polyester-system resin such as polyethylene terephthalate, polybutylene terephthalate and so forth, crystalline resin such as nylon, reinforced resin using crystalline resin based glass filler or glass fiber, carbon filler or carbon fiber, mica and so forth, foaming agent added foamable resin, amorphous resin such as polycarbonate, acrylonitrile butadiene styrene (ABS), polyphenylene ether (PPE) and so forth, or reinforced resin using amorphous resin based glass filler or glass fiber, carbon filler or carbon fiber, mica and so forth. The thermosetting resin, which can be used here, includes epoxy resin, vinylester resin, phenol resin and so forth.

The materials which are used for the continuous member 50P according to one or more embodiments of the present invention are lightweight, fatigue-resistant (durability against repeated bends), flexible (smooth movement), and are required to satisfy the need of adhesion property with respect to the rigidity member 50Q. Such materials are, for example, aramid fiber (meta system aramid fiber, para system aramid fiber), crystal liquid fiber, PBO fiber, ultrahigh molecular weight polyethylene fiber, polyester fiber, polypropylene fiber, nylon fiber, polyurethane fiber, natural fiber such as cotton cloth, and fabric and unwoven fabric using these fibers and so forth. Further, the continuous member 50P according to one or more embodiments of the present invention is surface treated to prevent peel-off when it adheres to the rigidity member 50Q. The surface treatment can include so-called primer treatment, specifically applying to or impregnate (add to) the continuous member 50P with thermosetting resin, for example, such as melamine resin (melamine-formaldehyde resin), phenol resin, epoxy resin, vinyl ester resin (epoxy acrylate resin) and so forth, and thermoplastic resin, for example, such as EVA resin (ethylene-vinyl acetate copolymer resin), polypropylene resin and so forth, which are known resin materials.

### [Embodiments and Examples of the Installation of the Speaker Device]

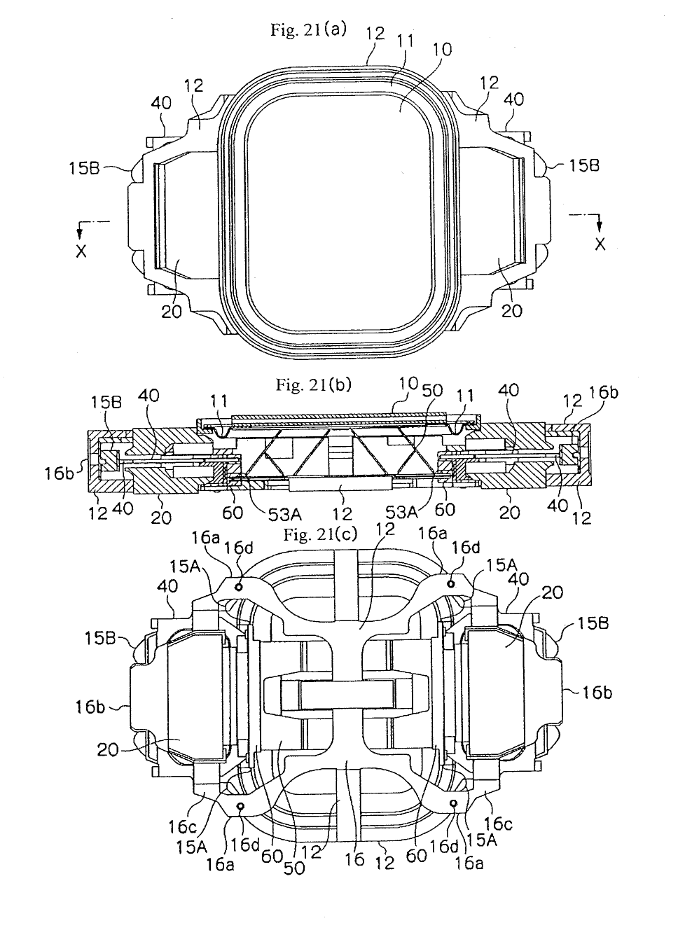

FIG. 21 is a view illustrating the speaker device according to an embodiment of the present invention (FIG. 21(a) is a plan view, FIG. 21(b) is a cross-sectional view taken along the line X-X, FIG. 21(c) is a back view). The same symbols are applied to the parts common in the aforementioned descriptions and the duplicate descriptions are not repeated. The example shown in FIG. 12 and FIG. 13 is adopted as the vibration direction converter part 50, and the first connecting part 53A is connected to the connecting part 60, and the vibration direction converter part 50 and the voice coil supporting part 40 are connected via the connecting part 60. The voice coil supporting part 40 is connected to the first connecting part 16a and the second connecting part 16b of the attachment unit 16 respectively via the first holding part 15A and the second holding part 15B. The frame 12 supports the periphery of the diaphragm 10 via the edge 11, as well as supports the magnetic circuit 20 and the attachment unit 16 in the rear side of the device.

According to this embodiment, the height of the magnetic circuit 20 is substantially equivalent to the total height of the overall device, and the voice coil supporting part 40 is configured to vibrate near the center of the magnetic circuit 20, such that the end part of the voice coil supporting part 40 and the end part of the vibration direction converter part 50 are connected via the connecting part 60 at different heights. As such, each link part in the vibration direction converter part 50 can keep sufficient length within the height in the device, and a part of the height of the magnetic circuit 20 can be covered within the height in the vibration direction converter part 50.

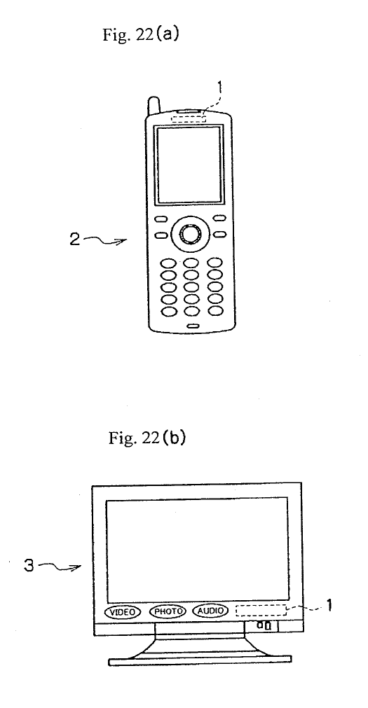

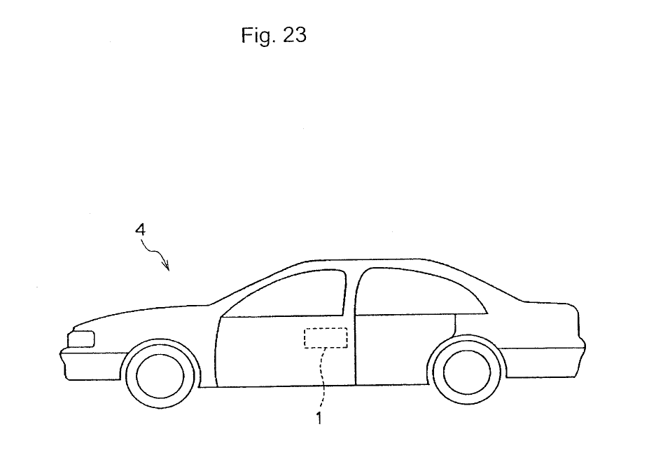

As described above, the speaker device according to an embodiment of the present invention can be made thin, and the loud sound can be realized. Such a speaker device can be effectively used for various kinds of electronic devices or in-car devices. FIG. 22 is a view illustrating an electronic device including the speaker device according to an embodiment of the present invention. An electronic device 2 such as a mobile phone or a personal digital assistance as shown in FIG. 22(a), or an electronic device 3 such as a flat panel display as shown in FIG. 22(b) can be configured so as to decrease the thickness which is necessary for the installation of the speaker device 1, whereby the whole electronic device can be made thin. Also, even in a thin shaped electronic device, a sufficient audio output can be obtained. FIG. 23 is a view illustrating a vehicle including the speaker according to an embodiment of the present invention. The vehicle 4 shown in FIG. 23 can expand the space in a vehicle owing to the thin shaped speaker device 1. In particular, if the speaker device 1 according to an embodiment of the present invention is installed inside a door panel, the protrusion of the door panel is reduced, thereby allowing the operation space for a driver to expand. Also, with sufficiently produced audio output, one can enjoy listening to music or radio broadcasts in a vehicle in a comfortable way even during noisy high-speed travel and so forth.

Further, when the speaker device 1 is installed in buildings including a residence building or a hotel, an inn, a training facility, etc., which can accommodate many guests for conferences, meetings, lectures, parties, etc., the installation space required for the speaker device 1 may be reduced in the thickness direction, whereby unused space can be reduced and the space can be effectively used. Further, a room including audiovisual equipment has burgeoned in recent years with prevalence of a projector or a big-screen TV. On the other hand, one can also use living room etc. as a theater room instead of having a room including audiovisual equipment. Also in such a case, a living room, etc. can be easily converted to a theater room by using the speaker device 1 while making effective use of the space in the living room. More particularly, the speaker device 1 may be installed, for example, on the ceiling, the wall and so forth in a room.

Although the embodiments according to the present invention are described with reference to the drawings, specific configurations are not limited to these embodiments, and modifications not departing from the subject matter of the present invention are included in the scope of the present invention. Accordingly, the scope of the invention should be limited only by the attached claims. Further, the technologies of each embodiment described above can be used by each other. Further, the technologies in the above each embodiment may be applied to dynamic speaker devices using a tabular voice coil (for example: Ryffel type speaker device, ribbon type speaker device, speaker device with magnetic pole parts arranged in the sound emission side and in the side opposite to the sound emission side of a tabular voice coil) as necessary, and thus the speaker device can be made thin. In addition, PCT/JP2008/051197 filed on Jan. 28, 2008, PCT/JP2008/068580 filed on Oct. 14, 2008, and PCT/JP2009/050764 filed on Jan. 20, 2009, are incorporated by reference into the present application.

1. A vibration direction converter part for speaker device direction converting a vibration of a voice coil supporting part supporting a voice coil, and vibrating a diaphragm in the direction different from said direction of said vibration of said voice coil supporting part, comprising:
a rigid link part angle-variably and obliquely disposed between said voice coil supporting part and said diaphragm; and
hinge parts formed at both end parts of said link part, wherein
said hinge part is formed with a bendable continuous member continuing between both side parts across said hinge part.

2. The vibration direction converter part for speaker device according to claim 1, comprising:
a first connecting part connected to said voice coil supporting part and vibrating integrally with said voice coil supporting part; and
a second connecting part connected to said diaphragm and vibrating integrally with said diaphragm, wherein
said link part and said first connecting part or said link part and second connecting part are formed across said hinge part.

3. The vibration direction converter part for speaker device according to claim 1, wherein
a link body is formed including a first connecting part connected to said voice coil supporting part and vibrating integrally with said voice coil supporting part, a second connecting part connected to said diaphragm and vibrating integrally with said diaphragm, and a plurality of said link parts, and
said link body includes:
a first link part such that said first connecting part is formed in the side of one end part thereof via said hinge part and said second connecting part is formed in the side of the other end part thereof via said hinge part; and
a second link part such that a middle part of said first link part is formed in the side of one end part thereof via said hinge part and a static part with respect to the vibration of said voice coil supporting part is formed in the side of the other end thereof via said hinge part,
said first link part and said second link part are obliquely disposed in different directions.

4. The vibration direction converter part for speaker device according to claim 3, comprising
a third link part such that an part integral with said first connecting part is formed in the side of one end part thereof via said hinge part and an part integral with said second connecting part is formed in the side of the other end part thereof via said hinge part,
wherein said first link part and said third link part form a parallel link part.

5. The vibration direction converter part for speaker device according to claim 1, wherein slant faces opposite each other are formed at end parts of both side parts across said hinge part.

6-9. (canceled)

10. The vibration direction converter part for speaker device according to claim 5, wherein
said link part is formed by integrating a rigidity member to said continuous member, and
all said hinge parts are formed in one side of either inner side or outer side of said rigidity member.

11. The vibration direction converter part for speaker device according to claim 3, wherein said link body includes at least four said hinge parts, and said link parts between the four hinge parts and said connecting parts form a parallelogram and said hinge parts are disposed near the corners of the parallelogram.

12. (canceled)

13. (canceled)

14. The vibration direction converter part for speaker device according to claim 1, wherein said hinge part is linearly formed.

15-18. (canceled)

19. The vibration direction converter part for speaker device according to claim 1, wherein said continuous member is formed with a fiber member.

20. The vibration direction converter part for speaker device according to claim 19, wherein said fiber member is arranged in said direction of said vibration of said voice coil supporting part.

21. The vibration direction converter part for speaker device according to claim 19, wherein said fiber member forms a fabric, and wherein said fabric is formed with warp and weft threads which are made of different materials.

22-25. (canceled)

26. The vibration direction converter part for speaker device according to claim 1, wherein said hinge part is formed to be thinner than said link part.

27. A speaker device, comprising:
a diaphragm; a frame vibratably supporting said diaphragm in the direction of the vibration; and a driving part provided at said frame, applying a vibration to said diaphragm in response to an audio signal, wherein
said driving part includes:
a magnetic circuit forming a magnetic gap in the direction different from said direction of said vibration of said diaphragm;
a voice coil supporting part supporting a voice coil to which an audio signal is inputted, being vibratably supported along said magnetic gap; and
a vibration direction converter part direction converting said vibration of said voice coil supporting part and transmitting said vibration to said diaphragm; and
said vibration direction converter part includes:
a rigid link part angle-variably and obliquely disposed between said voice coil supporting part and said diaphragm; and hinge parts formed at both end parts of said link part; and
said hinge part is formed with a bendable continuous member continuing between both side parts across said hinge part.

28. The speaker device according to claim 27, wherein
said vibration direction converter part includes one end part angle-variably connected to said driving part directly or via other member and the other end part angle-variably connected to said diaphragm directly or via other member,
said vibration direction converter part is obliquely disposed with respect to said direction of said vibration of said diaphragm and the moving direction of said driving part, respectively.

29. The speaker device according to claim 27, wherein
said vibration direction converter part includes a link body having a plurality of said link parts, wherein
said link part of said link body is angle-varied by receiving a reaction force from a static part arranged opposite said diaphragm.

30. (canceled)

31. The speaker device according to claim 27 comprising a link body, wherein
said link body includes a first connecting part connected to said voice coil supporting part, vibrating integrally with said voice coil supporting part, a second connecting part connected to said diaphragm, vibrating integrally with said diaphragm, and a plurality of said link parts, and
said link body includes:
a first link part such that a first connecting part is formed in the side of one end part of said first link part via said hinge part and a second connecting part is formed in the side of the other end part of said first link part via said hinge part; and
a second link part such that a middle part of said first connecting part is formed in the side of one end part of said second link part via said hinge part and a static part with respect to the vibration of said voice coil supporting part is formed in the side of the other end part of said second link part via said hinge part; and
said first link part and said second link part are obliquely disposed in different directions.

32. The speaker device according to claim 31, comprising
a third link part such that a part integral with said first connecting part is formed in the side of one end part of said third link part via said hinge part, and a part integral with said second connecting part is formed in the side of the other end part of said third link part via said hinge part,
wherein said first link part and said third link part form a parallel link.

33. (canceled)

34. The speaker device according to claim 28, wherein said static part is a part of said frame.

35. The speaker device according to claim 28, wherein said static part is formed with a static part of said link body with respect to the vibration of said voice coil supporting part.

36-41. (canceled)

42. An electronic device, wherein the electronic device includes a speaker device according to claim 27.

43. A vehicle, wherein said vehicle includes a speaker device according to claim 27.

44. A building, wherein said building includes a speaker device according to claim 27.
